(19) United States
(12) Patent Application Publication
(10) Pub. No.: US 2005/0200684 A1
(43) Pub. Date: Sep. 15, 2005

(54) Pattern formation method, pattern formation system, and electronic device

(75) Inventors: Kazuaki Sakurada, Suwa-shi (JP); Tsuyoshi Shintate, Matsuyama-machi (JP); Noboru Uehara, Simosuwa-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/068,874

(22) Filed: Mar. 2, 2005

(30) Foreign Application Priority Data
Mar. 9, 2004 (JP) 2004-065693
Mar. 10, 2004 (JP) 2004-067267
Oct. 27, 2004 (JP) 2004-312231
Dec. 27, 2004 (JP) 2004-376210

(51) Int. Cl. B41J 2/06

(52) U.S. Cl. 347/105

(57) ABSTRACT

A pattern formation method, a pattern formation system, and an electronic device are proposed, with which manufacture of a wiring pattern or an electronic circuit or the like can be accomplished at good efficiency and in high volume. A pattern is formed upon a reel to reel substrate, which is a tape shaped substrate, and of which the end portions are wound up upon a first reel and a second reel, by using, at least, a liquid drop ejection method in which a mass of liquid material is applied by being ejected in the form of liquid drops.

### BACKGROUND OF THE INVENTION

1. Field of the Invention

The present invention relates to a pattern formation method, to a pattern formation system, and to an electronic device.

Priority is claimed on Japanese Patent Application No. 2004-65693, filed Mar. 9, 2004, Japanese Patent Application No. 2004-67267, filed Mar. 10, 2004, Japanese Patent Application No. 2004-312231, filed Oct. 27, 2004, Japanese Patent Application No. 2004-376210, filed Dec. 27, 2004, the contents of which are incorporated herein by reference.

2. Description of Related Art

In the manufacture of wiring which is used in an electronic circuit or an integrated circuit or the like, for example, the lithographic method may be utilized. The lithographic method requires a large scale setup such as a vacuum device and the like, and is a complicated process. Furthermore, the lithographic method is one in which the utilization ratio of the material is of the order of a few percent, so that it is not possible to manage without wasting almost all of this material; and accordingly the cost of manufacture is high. In this connection, as a process which may be employed instead of the lithographic method, a method in which a liquid which includes a functional material is directly patterned upon the base material by an ink jet process has been tried (this is termed a liquid drop ejection method). For example, a method has been proposed in U.S. Pat. No. 5,132,248, in which a liquid in which minute electrically conductive particles have been dispersed is applied in a desired pattern directly to a substrate by a liquid drop ejection method, and subsequently heat processing and laser irradiation are performed, so as to convert the applied liquid into an electrically conductive layer pattern.

Furthermore, in a display device, or in a manufacturing method for a device, which utilizes a liquid drop ejection method, a means has been proposed in Japanese Patent Laid-Open Publication No. 2003-280535, which is able to correspond flexibly according to the type of manufacturing process which is employed. Taking the relative speed of the liquid drop ejection head with respect to the substrate as being V, the ejection period of the liquid drops as being D, and the diameter of the liquid drops which have hit the substrate and have spread out as being D, this means is one which controls the relative speed V, the ejection period T, and the drop diameter D, so as to satisfy the relationship VT<D. The liquid drops are ejected upon the substrate in the most suitable ejection conditions, according to the type of manufacturing process which is being employed.

### SUMMARY OF THE INVENTION

However, with the prior art wiring or display device manufacturing methods described in the above mentioned conventional art, for a plate shaped substrate, it is necessary to perform processing using a large number of processes upon the substrate for a single component. Thus, in order to execute these various processes, it is necessary to shift the substrate in order from the place (the device) where each process is performed to the place where the next process is to be performed. Due to this, with the manufacturing methods according to the above described prior arts, a great deal of work and machinery is required for shifting and for aligning this substrate and so on, and accordingly there is the problematical aspect that this invites increase of the cost of manufacture. In other words, with the prior art manufacturing methods, it is necessary to provide each of a liquid drop ejection device, a drying device, and so on, and it is necessary to align the substrate accurately with respect to each of these devices while shifting it in order between them, so that, in order to do this, it becomes necessary to employ a great deal of hand labor, and/or to provide a complicated and expensive shifting mechanism such as a robot or the like.

The present invention has been conceived in the light of the above described problems, and it takes as its objective to provide a pattern formation method, a pattern formation system, and an electronic device, with which it is possible to manufacture wiring or electronic circuits or the like with good efficiency and at high volume.

Furthermore, the present invention also takes, as another of its objectives, to provide a pattern formation method, a pattern formation system, and an electronic device, with which it is possible to manufacture wiring or electronic circuits or the like by using a liquid drop ejection method, while shifting a tape shaped substrate by a so-called reel to reel method.

In order to attain the above described objectives, the pattern formation method of the present invention is characterized in that a pattern is formed upon a reel to reel substrate, which is a tape shaped substrate, and of which each of both its end portions is wound up, by using, at least, a liquid drop ejection method, which is a method in which a mass of liquid material is applied by being ejected in the form of liquid drops.

Since, according to the present invention as described above, the pattern (for example, the wiring) is formed upon the reel to reel substrate by using a liquid drop ejection method, accordingly it is possible to manufacture the wiring or the electronic circuitry or the like with good efficiency and moreover in high volume. In other words, according to the present invention as described above, during manufacture of components, by aligning a desired region of a large quantity of single tape shaped substrate to a desired position of the liquid drop ejection device for ejecting liquid drops, it is possible to form the desired pattern in this desired position. This desired region corresponds to, for example, a single circuit substrate. Thus, after having formed the pattern with the liquid drop ejection device in this single desired region, by shifting the reel to reel substrate with respect to the liquid drop ejection device, it is possible to form another pattern in another desired region upon the same reel to reel substrate in an extremely simple manner. In this way, it is possible to form patterns easily and moreover quickly upon successive desired regions (circuit substrate regions) of the reel to reel substrate, and thus it is possible to manufacture the wiring or the electronic circuitry with good efficiency and moreover in high volume.

Furthermore, with the pattern formation method of the present invention as described above, it is desirable for a plurality of processes, including a liquid drop application process by said liquid drop ejection method, to be executed from when said reel to reel substrate is unwound to when it is wound up.

According to the present invention as described above, it is possible to shift the desired region of the reel to reel substrate from a device which executes, for example, one process to the next device which executes the next process, simply by winding up one end of the reel to reel substrate. Thus, according to the present invention, it is possible to simplify the transport mechanism and the alignment mechanism for shifting the substrate between the various devices for the various processes, and it is accordingly possible to reduce the cost of manufacture entailed by large scale production.

Furthermore, with the pattern formation method of the present invention as described above, it is desirable for at least two processes of said plurality of processes to be performed at the same time.

According to the present invention as described above, by performing a plurality of processes at the same time in an overlapped manner upon the single reel to reel substrate, it is possible to process the reel to reel substrate as though it was upon an assembly line. Accordingly, with the present invention, it is possible to execute a plurality of processes in parallel upon the single reel to reel substrate, using a plurality of devices, and thereby it is possible to perform manufacturing more quickly, and also to increase the efficiency of utilization of the various devices, so that it is possible to manufacture electronic circuit substrates or the like in a more efficient and economical manner.

Furthermore, with the pattern formation method of the present invention as described above, it is desirable for said plurality of processes to include, at least, a hardening process; and for said hardening process to be executed after having applied a mass of liquid material upon said reel to reel substrate by said liquid drop ejection method.

According to the present invention as described above, it is possible to make a thin film by hardening the mass of liquid material which has been applied upon the reel to reel substrate. For example, by applying another mass of liquid material for a second time over this thin film by a liquid drop ejection method, it is possible very simply to form a thin film of greater thickness. It would also be acceptable to perform the application of a mass of liquid material and the hardening process more than twice, and, thereby, it would be possible to form a thin film of any desired thickness.

Furthermore, with the pattern formation method of the present invention as described above, it is desirable for the time which is required for each of said plurality of processes to be almost the same.

According to the present invention as described above, it is possible to perform the various processes in parallel at the same time as one another, and, along with it being thereby possible to perform manufacture more quickly, it is also possible to enhance the efficiency of utilization of the various devices for performing the various processes. In order thus to make the time periods which are required for the various to be the same as one another, it will be acceptable to adjust the number or the performance of the various devices for performing the various processes. For example, if the liquid drop application process takes a longer period of time than do the other processes, it will be acceptable to utilize a plurality of liquid drop ejection devices for that liquid drop application process.

Furthermore, with the pattern formation method of the present invention as described above, it is desirable for said plurality of processes to include: a surface processing process in which a lyophilic characteristic or a lyophobic characteristic is imparted to the surface of said reel to reel substrate; an application process, which is executed after said surface processing process, in which a mass of liquid material is applied to said reel to reel substrate by said liquid drop ejection method; and a hardening process, which is performed after having performed said application process, and in which said mass of liquid material which has been applied to said reel to reel substrate is hardened.

In more concrete terms, it is desirable for said plurality of processes to include said plurality of processes to include: a cleansing process in which the surface of said reel to reel substrate is cleansed; a surface processing process, which is performed after having performed said cleansing process, and in which a lyophilic characteristic or a lyophobic characteristic is imparted to the surface of said reel to reel substrate; a wiring material application process, which is performed after having performed said surface processing process, and in which a mass of liquid material which includes an electrically conductive material is applied to said reel to reel substrate by said liquid drop ejection method; a wiring material drying process, which is performed after having performed said wiring material application process, and in which said mass of liquid material which includes said electrically conductive material is dried; an insulating material application process, which is performed after having performed said wiring material drying process, and in which a mass of liquid material which has an insulating characteristic is applied by said liquid drop ejection method to the upper layer of the region upon which said wiring material drying process has been performed; and an insulating material hardening process, which is performed after having performed said insulating material application process, and in which said mass of liquid material which has an insulating characteristic is hardened.

According to the present invention as described above, for example, it is possible to make the area outside the application region for the mass of liquid material lyophobic by the surface processing process, so that it is possible to produce a pattern which is more accurately shaped in a simple and yet efficient manner. Furthermore, according to the present invention, it is possible to form a plurality of layers of pattern at high accuracy, by repeating the surface performing process, the application process, and the drying process upon a single region of the reel to reel substrate. Yet further, according to the present invention, by including a wiring material application process, a wiring material hardening process, an insulating material application process, and an insulating material hardening process, it is possible to form an insulating layer as an upper layer over the wiring layer.

Furthermore, with the pattern formation method of the present invention as described above, it is desirable for said plurality of processes to comprise a firing process, in which said reel to reel substrate, upon which at least said insulating material application process has been performed, is fired. Yet further, with the pattern formation method of the present invention as described above, it is desirable for the process among said plurality of processes which is executed last to be said firing process in which said reel to reel substrate is fired.

According to the present invention as described above, for example, it is possible to fire both the wiring material and the insulating material which have been hardened upon the reel to reel substrate together. Accordingly, with the present invention, as compared to the case of performing the firing of the wiring material and the firing of the insulating material separately, it is possible to manufacture a circuit substrate or the like more quickly and also at higher efficiency.

Furthermore, with the pattern formation method of the present invention as described above, it is desirable for a wiring material application process, in which a pattern is printed upon said reel to reel substrate by ejecting liquid drops including an electrically conductive material, to be performed from when said reel to reel substrate is unwound to when it is wound up; and for, before said mass of liquid material which has been applied hardens, said reel to reel substrate to be wound up.

Since, according to the present invention as described above, even though the tape shaped substrate is bent by being wound up, it is possible to perform this bending of the mass of liquid material in a gentle manner before it has hardened, accordingly it is possible to prevent the generation of cracking or of abrasion or the like in the wiring pattern. Thus, it is possible to form a wiring pattern with superb reliability.

Furthermore, with the pattern formation method of the present invention as described above, it is desirable for the winding up of said reel to reel substrate to be performed in a state in which said mass of liquid material which has been applied has been tentatively dried to an extent at which said mass of liquid material which has been applied has lost its flowability.

According to the present invention as described above, it is possible to prevent deformation of the mass of liquid material due to its flowing while the tape shaped substrate is being wound up.

Furthermore, with the pattern formation method of the present invention as described above, it is desirable for the winding up of said reel to reel substrate to be performed while positioning, against the surface of said tape shaped substrate upon which said mass of liquid material has been applied, a tape shaped spacer which covers the application region of said mass of liquid material.

According to the present invention as described above, it becomes possible to wind up the tape shaped substrate while preventing crushing of the mass of liquid material against the portion of the tape shaped substrate which has already been wound up. Accordingly, it becomes easy to form the desired pattern upon the tape shaped substrate in a reliable and yet easy manner.

Furthermore, with the pattern formation method of the present invention as described above, it is desirable for convex portions to be formed upon the surface of said tape shaped spacer; and for the winding up of said reel to reel substrate to be performed while contacting said convex portions of said tape shaped spacer against a region of said tape shaped substrate other than the application region of said mass of liquid material.

According to the present invention as described above, it is possible to cover the application region for the mass of liquid material upon the tape shaped substrate with the region of the tape shaped spacer other than its convex portions. By doing this, along with preventing contact of the mass of liquid material which has been applied with the exterior, it also becomes possible to wind up the tape shaped substrate without any problems occurring. Accordingly, it becomes possible to form the desired pattern simply and easily.

Furthermore, with the pattern formation method of the present invention as described above, it is desirable for said convex portions to be formed on both end portions of said tape shaped spacer in its widthwise direction; for winding up holes of said tape shaped substrate to be formed in a row along both end portions in the widthwise direction of said tape shaped substrate; and for the winding up of said reel to reel substrate to be performed while engaging the ends of said convex portions of said tape shaped spacer into said winding holes in said tape shaped substrate.

Since, according to the present invention as described above, it is possible to prevent relative positional slippage of the tape shaped substrate and the tape shaped spacer, accordingly it is possible securely to ensure the application region for the mass of liquid material upon the tape shaped substrate.

According to another aspect of the present invention, in order to attain the above described objectives, the pattern formation system of the present invention is characterized by comprising: a first reel upon which a tape shaped substrate is wound; a second reel upon which said tape shaped substrate, which has been pulled off from said first reel, is wound up; a liquid drop ejection device which comprises an ejection head which ejects a mass of liquid material as liquid drops against said tape shaped substrate, which has been pulled off from said first reel; and a head shifting mechanism, which shifts said ejection head relatively to said tape shaped substrate, which has been pulled off from said first reel.

According to the present invention as described above, by shifting the ejection head with the head shifting mechanism relatively with respect to the predetermined region upon the tape shaped substrate, it is possible to form the pattern by adhering the liquid drops in the desired positions upon said predetermined region. After having formed the desired pattern upon a single desired region of the tape shaped substrate, by shifting the tape shaped substrate in its lengthwise direction, it is possible to form another pattern upon another desired region in an extremely simple and easy manner. Thus, it is possible for a single circuit substrate to correspond to a single one of the desired regions. With the present invention, it is possible to form a pattern simply and moreover quickly upon each of the desired regions of the tape shaped substrate (i.e. upon each of the circuit substrate regions thereof), so that it is possible to manufacture wiring or an electronic circuit or the like with good efficiency and moreover in high volume.

Furthermore, with the pattern formation system of the present invention as described above, it is desirable for there to be included a guide rail, which is a structural element of said liquid drop ejection device, and which, during liquid drop ejection operation by said liquid drop ejection device, causes said ejection head to be shifted in a direction which intersects the lengthwise direction of said tape shaped substrate almost orthogonally.

According to the present invention as described above, for example, by shifting the ejection head along the guide while maintaining the state of the tape shaped substrate in which it is fixed, it is possible to shoot the liquid drops onto the tape shaped substrate in the desired positions along its widthwise direction (its short direction). Since, with the present invention, the guide is arranged so as to be almost orthogonal to the lengthwise direction of the tape shaped substrate, accordingly it is possible to eject the liquid drops in more accurate positions.

Furthermore, with the pattern formation system of the present invention as described above, it is desirable for there to be provided flushing areas, which are regions which are arranged at both sides of said tape shaped substrate in its short direction, and which, along with being regions to which said ejection head can be shifted via said guide, are regions in which said liquid material can be cleaned off said ejection head and discarded.

Since, according to the present invention as described above, the flushing areas are provide at both sides of the tape shaped substrate along its short direction (its widthwise direction), accordingly it is possible to shift the ejection head to one or the other of these flushing areas at high speed. In other words, it is possible to position the flushing areas in the vicinity of the application region (the predetermined region) which is one location upon the tape shaped substrate, which is extremely long. Furthermore, it is possible to shift the ejection head to either of these two flushing areas for flushing, along the guide, and then to shift it back to the application region of the tape shaped substrate at high speed.

Furthermore, with the pattern formation system of the present invention as described above, it is desirable for said tape shaped substrate to be wound up upon said second reel so that the surface of said tape shaped substrate upon which said mass of liquid material has been applied faces inwards.

Since, according to the present invention as described above, it is possible to keep the pattern in a desirable state, just as it is, since the tape shaped substrate is wound up so that the pattern which has been formed upon said tape shaped substrate faces towards the inside.

Furthermore, with the pattern formation system of the present invention as described above, it is desirable for said liquid drop ejection device to include an ejection head which ejects liquid drops towards the front surface and the rear surface of said tape shaped substrate at almost the same time. Even further, said liquid drop ejection device may include an ejection head which ejects liquid drops towards the front surface and the rear surface of said tape shaped substrate at almost the same time, while holding said surfaces of said tape shaped substrate in a substantially vertical orientation.

According to the present invention as described above, it is possible to apply the mass of the liquid material to both the one side and also to the other side of the tape shaped substrate at high speed and in a simple manner.

Furthermore, with the pattern formation system of the present invention as described above, it is desirable for there to be further included a reversing mechanism which twists said tape shaped substrate so as to interchange its front surface and its rear surface, and for said liquid drop ejection device to include a first ejection head which ejects liquid drops against the upper surface of said tape shaped substrate before it has thus been twisted by said reversing mechanism, and a second ejection head which ejects liquid drops against the new upper surface of said tape shaped substrate after it has thus been twisted by said reversing mechanism.

According to the present invention as described above, it is possible to reverse the tape shaped substrate with the reversing mechanism, so that it is possible first to apply liquid drops to one side of the tape shaped substrate with the first ejection head, and subsequently to apply liquid drops to the other side of the tape shaped substrate with the second ejection head. Accordingly, with the present invention as described above, it is possible to apply the mass of liquid material to both sides of the tape shaped substrate with a liquid drop ejection method.

According to still another aspect of the present invention, in order to attain the above described objectives, the electronic device of the present invention is characterized by having been manufactured using a pattern formation method as described above, or using a pattern formation system as described above.

According to the present invention as described above, it is possible to provide a number of electronic devices which include a substrates which consist of thin films, and upon each of which wiring or an electronic circuit or the like has been formed, by cutting the single tape shaped substrate (reel to reel substrate) up into pieces which correspond to the desired regions thereupon.

In order to attain the above described objective, the pattern formation system of the present invention includes: a substrate arrangement means which arranges a plurality of tape shaped substrates so that they are mutually parallel; and a liquid drop ejection device, which comprises at least one ejection head which ejects a mass of liquid material in the form of liquid drops towards said plurality of tape shaped substrates which have been arranged by said substrate arrangement means.

According to the present invention as described above, it is possible to apply the mass of liquid material to the plurality of tape shaped substrates which are arranged so as to be mutually parallel to one another by using a single common ejection head. For example, suppose that the width of the tape shaped substrate is 10 cm, and its length is 200 m, while the distance through which the ejection head of the liquid drop ejection device can shift along the transverse direction of the tape shaped substrate is 1 m. If ten of these tape shaped substrates are arranged to be parallel to one another with substantially no gaps being left between them, then it is possible to apply the mass of liquid material to each of the tape shaped substrates with this single liquid drop ejection device. Thus, according to the present invention, it is possible to form patterns at high speed upon a plurality of tape shaped substrates while operating the liquid drop ejection device in an extremely efficient manner. Moreover, according to the present invention as described above, it is possible to reduce the space which is required for setting up the manufacturing device, and it is also possible to reduce the cost of manufacture.

Furthermore, with the pattern formation system of the present invention as described above, it is desirable for said tape shaped substrates to be reel to reel substrates of which both the end portions are wound up, and for said liquid drop ejection device to regulate the shift position of said ejection head, and to include a guide which is arranged so as to cross said plurality of tape shaped substrates.

Since, according to the present invention as described above, the guide for the ejection head is used in common for all of the plurality of reel to reel substrates (tape shaped substrates), accordingly it is possible to enhance the efficiency of utilization of the liquid drop ejection device in a very simple and convenient manner. For example, by shifting (scanning) the ejection head once along the guide, it is possible to scan the ejection head once across each of the plurality of reel to reel substrates. Accordingly, as compared to the case in which a single liquid drop ejection device is employed for each of the reel to reel substrates, this concept according to the present invention, in which a single liquid drop ejection device and a single guide are utilized for each of the plurality of reel to reel substrates, is able, as a whole, to reduce the shifting distance of the ejection head, and accordingly to apply the mass of liquid material in a more efficient manner.

Furthermore, with the pattern formation system of the present invention as described above, it is desirable for said liquid drop ejection device to include a plurality of said ejection heads.

According to the present invention as described above, it is possible to apply the mass of liquid material by ejecting it against the plurality of tape shaped substrates which are provided in parallel with the plurality of ejection heads. Accordingly, with this aspect of the present invention, it is possible to form the patterns more quickly.

Furthermore, with the pattern formation system of the present invention as described above, it is desirable for said plurality of ejection heads to be all supported in common by said guide so as to be able to shift.

Since, according to the present invention as described above, the plurality of ejection heads are arranged to be shifted along the common guide, accordingly it is possible to anticipate that the liquid drop ejection device will become more compact and that the space which is required for setting up the manufacturing device will be reduced, since it is possible to form the patterns quickly.

Furthermore, with the pattern formation system of the present invention as described above, it is desirable for said liquid drop ejection device to include a plurality of said guides, and for each of said plurality of said guides to support at least one of said ejection heads so that it is able to shift.

According to the present invention as described above, it is possible for each of the ejection heads upon each of the guides to apply the liquid drops against the desired tape shaped substrates. Therefore, according to the present invention, while further increasing the speed of pattern formation, it is possible to anticipate that the liquid drop ejection device will become more compact and that the space which is required for setting up the manufacturing device will be reduced.

Furthermore, with the pattern formation system of the present invention as described above, it is desirable for there to be included a reel drive section which shifts said plurality of tape shaped substrates along their lengthwise directions in common; and, as said reel drive section, it is desirable to include a plurality of reels, one of which is provided for each of said plurality of tape shaped substrates, and for said plurality of reels, upon each of which one of said tape shaped substrates is wound up, to be rotated all together.

According to the present invention as described above, it is possible to shift the plurality of tape shaped substrates by using a single reel drive section. Therefore, it is possible to perform the shifting of the plurality of tape shaped substrates from a device which performs one process to the next device which performs the subsequent process with this single reel drive section. Thus, with the present invention as described above, it is possible to form patterns at high efficiency upon the plurality of tape shaped substrates, and it is possible to reduce the cost of manufacture.

Furthermore, with the pattern formation system of the present invention as described above, it is desirable for said liquid drop ejection device to include a plurality of stages, upon each of which a desired region of one of said plurality of tape shaped substrates is mounted, and a plurality of alignment means, each of which determines the position of a corresponding one of said desired regions of said tape shaped substrates which have been mounted upon a corresponding one of said stages.

According to the present invention as described above, it is possible to align each of the desired regions of each of the tape shaped substrates upon its corresponding stage. Thus, with the present invention, it becomes easy to position the desired region of each of the tape shaped substrates individually, and it becomes possible to form the desired patterns upon each of the tape shaped substrates with high accuracy.

Furthermore, with the pattern formation system of the present invention as described above, it is desirable for said liquid drop ejection device to include a stage upon which the desired regions of said plurality of tape shaped substrates are simultaneously mounted, and an alignment means which determines the positions of said desired regions of said tape shaped substrates which have been mounted upon said stage.

According to the present invention as described above, it is possible to perform alignment of each of the plurality of tape shaped substrates, while using this single stage. Thus, with the present invention, it is possible to simplify the structure of the system as a whole, while being able to form patterns upon the plurality of tape shaped substrates at low cost.

Furthermore, with the pattern formation system of the present invention as described above, it is desirable for there to be included a pair of flushing areas, which are regions in which liquid material is cleansed off from said ejection head and discarded, and which are a pair of regions which are positioned outward of said tape shaped substrates, at each side in the transverse direction of said plurality of tape shaped substrates, which are disposed by said substrate arrangement means so as to be mutually parallel to one another.

According to the present invention as described above, when applying the mass of liquid material with the liquid drop ejection method to the plurality of tape shaped substrates, it is possible to utilize these two flushing areas in common. Thus, with the present invention as described above, it is not necessary to perform flushing operation for each of the tape shaped substrates on an individual basis, and accordingly it is possible to form the desired patterns upon the plurality of tape shaped substrates more efficiently.

In order to attain the above described objectives, the pattern formation method of the present invention is a method in which a pattern is formed, characterized by comprising: an arrangement process, in which a plurality of reel to reel substrates which are tape shaped substrates, and of which each of both its end portions is wound up, are arranged so as to be mutually parallel to one another; and a liquid drop application process, in which a mass of liquid material is applied to said plurality of reel to reel substrates by being ejected in the form of liquid drops, using a common ejection head.

According to the present invention as described above, it is possible to apply the mass of liquid material with the common ejection head to the plurality of reel to reel substrates which are arranged so as to lie parallel to one another. Accordingly, with the present invention as described above, it is possible to form the same pattern upon each of the plurality of reel to reel substrates at almost the same time. Thus, with the present invention, it is possible to form patterns upon the plurality of reel to reel substrates at high speed, so that it is possible to reduce the cost of manufacture.

Furthermore, with the pattern formation method of the present invention as described above, it is desirable for a plurality of said liquid drop application processes to be included, from when said reel to reel substrates are unwound to when they are wound up; and for said plurality of processes to be executed upon said plurality of reel to reel substrates while being mutually overlapped in time.

According to the present invention as described above, by executing the plurality of processes upon each of the plurality of reel to reel substrates as overlapped at the same time, it is possible to form patterns upon each of the reel to reel substrates at the same time on an assembly line basis. Accordingly, with the present invention as defined above, it is possible to execute a plurality of processes with a plurality of devices in parallel, and thus it is possible to perform the manufacturing process more quickly, and moreover it is possible to enhance the efficiency of utilization of each of the devices for each of the processes, and it is possible to perform mass production of electronic circuit substrates or the like at low cost without any sacrifice of quality.

Furthermore, with the pattern formation method of the present invention as described above, it is desirable for, in said plurality of processes, the timing for shifting from each process to the subsequent process to be almost the same for all of said plurality of reel to reel substrates.

According to the present invention as described above, it is possible to perform the various processes at the same time in parallel upon each of the plurality of reel to reel substrates. Accordingly, with the present invention as defined above, along with it being possible to perform the manufacturing process more quickly, it is also possible to enhance the efficiency of utilization of each device for each process. In order to make the times which are required for the various processes to agree with one another, it will be acceptable to adjust the number or the performance of the devices which are used for the various processes. For example, if the liquid drop application process takes a longer time than the other processes, it is desirable to use a plurality of ejection heads, or a plurality of liquid drop ejection devices.

In order to attain the above described objective, the pattern formation method of the present invention is a method in which a pattern is formed, characterized in that: a single tape shaped substrate is folded to and fro in its lengthwise direction, so that a plurality of locations upon said tape shaped substrate in its lengthwise direction extend parallel to one another; and in that there is included a liquid drop application process in which a mass of liquid material is applied to said plurality of locations by being ejected in the form of liquid drops, using a common ejection head.

According to the present invention as described above, by folding the tape shaped substrate to and fro using, for example, rollers or the like, and by thus arranging a plurality of locations upon this tape shaped substrate so that they lie parallel to one another, it is possible to apply the mass of liquid material to this plurality of locations upon the tape shaped substrate by using a single ejection head. Accordingly, with the present invention as described above, it is possible to form patterns at almost the same time upon a plurality of locations upon a single tape shaped substrate by using a single ejection head. Thus, with the present invention as defined above, it is possible to form a plurality of patterns upon a single tape shaped substrate at high speed, and accordingly it is possible to reduce the manufacturing cost.

Furthermore, in order to attain the above described objective, the electronic device of the present invention is characterized by having been manufactured using a pattern formation method as described above, or using a pattern formation system as described above.

According to the present invention as described above, it is possible to provide at low cost an electronic device which includes a substrate which includes wiring or an electronic circuit made from a thin film which is a substrate, and which has been made by cutting away a desired region from, for example, a tape shaped substrate (a reel to reel substrate).

### BRIEF DESCRIPTION OF THE DRAWINGS

FIG. 1 is a schematic perspective view showing an overall view of a pattern formation system according to a first preferred embodiment of the present invention.

FIG. 2 is a perspective view showing a liquid drop ejection device of the above pattern formation system.

FIGS. 3A and 3B are figures showing an ink jet head of the above liquid drop ejection device.

FIG. 4 is a bottom view of this ink jet head.

FIG. 5 is a partial plan view showing the arrangement of a flushing area of this liquid drop ejection device and so on.

FIGS. 6A, 6B and 6C are perspective views showing an electronic device according to a preferred embodiment of the present invention.

FIG. 7 is an explanatory figure showing a pattern formation method according to a second preferred embodiment of the present invention.

FIG. 8 is a figure for explanation of a process of arranging a tape shaped spacer upon the surface of a tape shaped substrate.

FIGS. 9A and 9B are figures for explanation of a wiring pattern.

FIG. 10 is a process diagram for a method of forming this wiring pattern.

FIG. 11 is an exploded perspective view of a liquid crystal module of a COF construction.

FIG. 12 is a schematic perspective view of a pattern formation system according to a third preferred embodiment of the present invention.

FIG. 13 is a schematic perspective view of a pattern formation system according to a fourth preferred embodiment of the present invention.

FIG. 14 is a schematic perspective view of a pattern formation system according to a fifth preferred embodiment of the present invention.

### DETAILED DESCRIPTION OF THE PREFERRED EMBODIMENTS

### The First Preferred Embodiment

In the following, first preferred embodiments of the pattern formation system and of the pattern formation method according to the present invention will be explained with reference to the drawings. The pattern formation method according to this preferred embodiment of the present invention may be implemented by using the pattern formation system according to this preferred embodiment of the present invention. For these preferred embodiments, by way of example, the explanation will be made in terms of a pattern formation system and a pattern formation method which form a wiring pattern which is made from a thin electrically conductive film, upon a tape shaped substrate which is implemented as a reel to reel substrate.

The Pattern Formation System

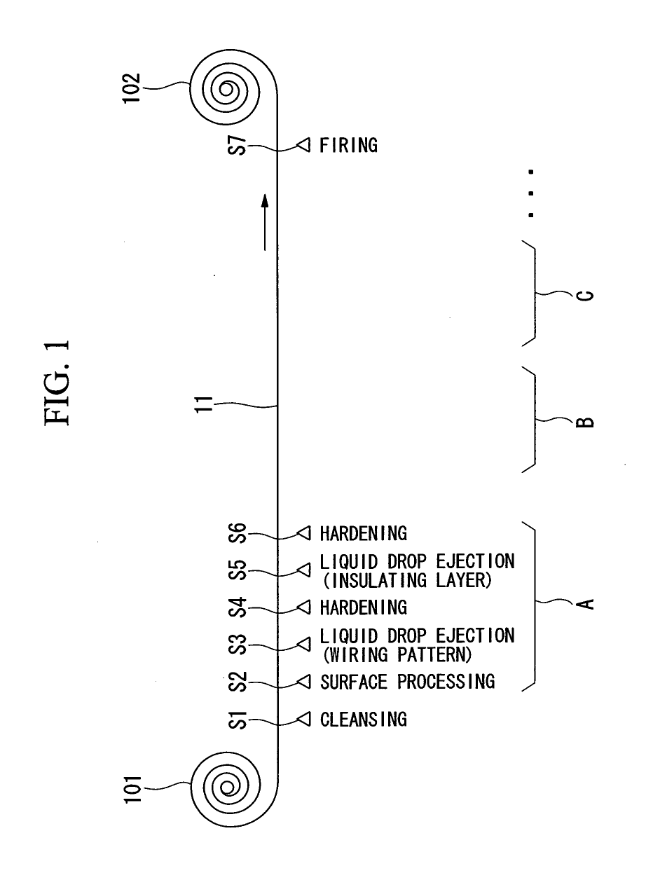

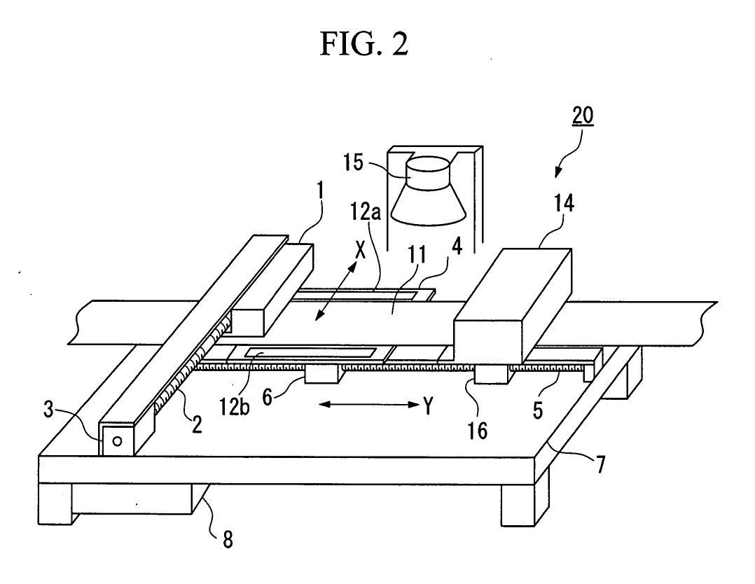

FIG. 1 is a schematic figure showing the essential elements of the pattern formation system and of the pattern formation method according to this first preferred embodiment of the present invention. FIG. 2 is a perspective view showing an example of a liquid drop ejection device which is an important structural element of this pattern formation system. This pattern formation system comprises, at least, a first reel 101 upon which a tape shaped substrate 11 is wound up, a second reel 102 upon which the tape shaped substrate 11 is wound after it has been pulled off the first reel 101, and a liquid drop ejection device 20 which ejects liquid drops against this tape shaped substrate 11.

A flexible substrate in, for example, belt form or the like may be applied for this tape shaped substrate 11, and this may be made from a base material such as polyimide or the like. A concrete example of the dimensions of such a tape shaped substrate 11 is: width 105 mm, length 200 m. This tape shaped substrate 11 is made as a “reel to reel substrate”, with the two end regions of its belt form being wound up, respectively, upon the first reel 101 and upon the second reel 102. In other words, the tape shaped substrate 11 is forwarded continuously in its lengthwise direction, being wound off from the first reel 101 and being wound up upon the second reel 102. The liquid drop ejection device 20 ejects a liquid substance in a predetermined pattern in the form of liquid drops against this tape shaped substrate, as it is thus being continuously forwarded, thus performing “liquid drop ejection”.

Furthermore, this pattern formation system comprises a plurality of devices which execute a plurality of respective processes upon the reel to reel substrate which consists of the single tape shaped substrate 11. As this plurality of processes there may be cited, for example, a cleansing process S1, a surface processing process S2, a first liquid drop ejection process S3, a first hardening process S4, a second liquid drop ejection process S5, a second hardening process S6, and a firing process S7. By these processes, a wiring layer and an insulation layer and the like are formed upon the tape shaped substrate 11.

Furthermore, with this pattern formation system, large scale substrate formation regions (desired regions) are set by further dividing the tape shaped substrate 11 in the lengthwise direction into prescribed lengths. The wiring layer and the insulating layer and the like are continuously formed upon each of these substrate formation regions of the tape shaped substrate 11 by shifting the tape shaped substrate 11 continuously to each device for each process. In other words, the plurality of processes S1 through S7 are executed upon an assembly line basis by the plurality of devices, all at the same time, i.e. as temporally superimposed upon one another.

The Pattern Formation Method

Next, the above described plurality of processes which are performed upon the tape shaped substrate 11, which is the reel to reel substrate, will be explained in concrete terms.

First (in the step S1) the cleansing process S1 is performed upon the desired region upon the tape shaped substrate 11 which has been pulled off from the first reel 101.

As a concrete example of such a cleansing process S1, there may be cited UV (ultraviolet ray) illumination of the tape shaped substrate 11. Furthermore, it would also be acceptable to cleanse the tape shaped substrate 11 with water or some other solvent, or to cleanse it using ultrasonic waves. Yet further, it would also be acceptable to perform such cleansing by irradiating the tape shaped substrate 11 with a plasma.

Next (in the step S2) a surface processing process is performed upon the desired region of the tape shaped substrate upon which this cleansing process S1 has been performed by endowing it with a lyophilic or with a lyophobic characteristic.

A concrete example of such a surface processing process S2 will now be explained. In order to form, in the step S3, the electroconductive layer wiring pattern upon the tape shaped substrate 11 with the first liquid drop ejection process S3 using a liquid which includes minute electrically conductive particles, it is desirable to control the wettability of the desired region of the tape shaped substrate with respect to this liquid in which the minute electroconductive particles are included. In the following, a surface processing method for obtaining the desired angle of contact will be explained.

In this preferred embodiment, in order to bring the predetermined angle of contact with respect to the liquid which includes the minute electrically conductive particles to the desired value, first, lyophobic processing is performed upon the surface of the tape shaped substrate 11, and furthermore, thereafter, a second stage of surface processing is performed, in which lyophilization processing is performed in order to mitigate the lyophobic state.

First, the method of performing lyophobic processing upon the surface of the tape shaped substrate 11 will be explained.

As one method for such lyophobic processing, there may be cited a method of forming a self organized layer which consists of organic macromolecules upon the surface of the substrate. Such an organic macromolecule for processing the surface of the substrate is one which possesses a functional group at its one end which can combine with the substrate, and which, along with possessing a functional group at its other end which reforms the surface of the substrate lyophobically or the like (i.e. which controls its surface energy), is also provided with a carbon chain which either directly links these functional groups, or which is partially branched from them; and such macromolecules self-organize by combining with the substrate—for example, they may be formed as unitary macromolecules.

The self organized layer consists of combined functional groups which can react with the constituent atoms of the underneath layer such as the substrate or the like, and, apart from these groups, straight chain molecules, and it is a layer which has been formed by orienting a compound which is endowed with extremely high orientability due to the mutual action of said straight chain molecules. Since this self organized layer is formed by orienting individual molecules, it can be made to be extremely thin, and, moreover, it can be made as a film the level of whose molecules is uniform. In other words, since the positions of the molecules at the surface of the layer are all the same, it is possible to endow the surface of the layer with a uniform and moreover excellent lyophobic characteristic, or the like.

If, for example, a fluoro-alkyl-silane is used as the above described compound which is endowed with high orientability, then, since the self organized layer is formed by orienting this compound so that the fluoro-alkyl base at the surface of the layer, accordingly the surface of the layer is endowed with a uniform lyophobic characteristic.

As the compound for forming the self organized layer there may be cited, for example, fluoro-alkyl-silanes (hereinafter termed “FAS”) such as penta-deca-fluoro-1,1,2,2-tetra-hydro-decyl-tri-ethoxy-silane, penta-deca-fluoro-1,1,2,2-tetra-hydro-decyl-tri-methoxy-silane, penta-deca-fluoro-1,1,2,2-tetra-hydro-decyl-tri-chloro-silane, tri-deca-fluoro-1,1,2,2-tetra-hydro-octyl-tri-ethoxy-silane, tri-deca-fluoro-1,1,2,2-tetra-hydro-octyl-tri-methoxy-silane, tri-deca-fluoro-1,1,2,2-tetra-hydro-octyl-tri-chloro-silane, tri-fluoro-propyl-tri-methoxy-silane, and the like. Although, when used, it is desirable to use only one compound individually, the present invention is not to be considered as being limited to such individual use; provided that the desired objectives of the present invention are not lost sight of, two or more of these compounds may be used in combination. Furthermore although, with these first preferred embodiments of the present invention, said FAS are used as the compounds from which said self organized layer is to be formed, it is desirable to endow them with tight adhesion to the substrate and with a desirable lyophobic characteristic.

This self organized layer which consists of organic macromolecules or the like is formed by putting the above described raw material compound and the substrate into the same closed container, and by letting it stand for around two to three days, if at room temperature. Furthermore, it is possible to form it upon the substrate in about three hours by keeping the entire closed container at 100° C. As has been described above, although there is a method of forming the self organized layer from the gaseous phase, it is also possible to form it from the liquid phase. For example, the self organized layer may be formed upon the substrate by dipping it into a solution which contains a raw material compound, and then cleansing it and drying it.

It should be understood that, before forming the self organized layer, it is desirable to perform pre-processing by irradiating ultraviolet light upon the substrate surface in by the cleansing process S1 of the step S1, and/or by cleansing it with a solvent.

As another method of performing this lyophobic processing, there may be suggested a method of plasma irradiation at atmospheric pressure. Various types of gas may be selected to be used for such plasma processing, in consideration of the nature of the surface material of the substrate and so on. For example, a fluorocarbon type gas such as 4-fluoro-methane, perfluorohexane, perfluorodecane or the like may be used as the processing gas. In such a case, it is possible to form a lyophobic fluorinated compound layer upon the surface of the substrate.

This lyophobic processing may also be performed by adhering to the surface of the substrate a film which is endowed with the desired lyophobic characteristic—for example, a polyimide film to which 4-fluoro-ethylene has been added. It should be understood that it would also be acceptable to utilize the polyimide film just as it is, as the tape shaped substrate 11.

Next, the method for performing the lyophilization processing will be explained.

Since, at the stage when the above described lyophobic processing has been completed, the substrate surface is endowed with a higher lyophobic characteristic than is normally desired, this lyophobic characteristic is mitigated by lyophilization processing.

As such lyophilization processing, there may be cited a method of irradiating the workpiece with ultraviolet light of wavelength from 170 to 400 nm. By doing this, it is possible to eliminate the lyophobic layer which has been temporarily formed, either partially or entirely, in an even and uniform manner, and thereby it is possible to mitigate its lyophobic characteristic.

In this case, although it is possible to vary the amount of mitigation by adjusting the ultraviolet light irradiation time, it is also possible to adjust the intensity of this ultraviolet light, and/or its wavelength, and/or to perform heat processing; and it is also possible to apply a combination of these treatments.

As another method for performing the lyophilization processing, there may be cited plasma processing with a gas which reacts with oxygen. By doing this, it is possible partially or completely to mitigate the lyophobic characteristic of the lyophobic layer which has been temporarily formed by causing its properties to be degenerated uniformly.

As yet another method of performing this lyophilization processing, there may also be cited the method of processing by exposure to an ozone atmosphere. By doing this, it is possible to convert the lyophobic layer which has been temporarily formed either partially or entirely, in a uniform manner, and it is possible thus to mitigate the lyophobic characteristic. In this case, it is possible to adjust the amount of mitigation of the lyophobic characteristic which is performed by adjusting the irradiation output, the distance, the time period, or the like.

Next (in the step S3) the first liquid drop ejection process S3 is performed by executing a wiring material application process, in which a liquid which includes minute electrically conductive particles is applied by being ejected against the desired region upon the tape shaped substrate 11.

The liquid drop ejection of this first liquid drop ejection process S3 is performed by the liquid drop ejection device 20 shown in FIG. 2. When forming a wiring pattern upon the tape shaped substrate 11, the mass of liquid material which is ejected by this first liquid drop ejection process is a mass of liquid material which includes minute electrically conductive particles (the pattern formation component). As the mass of liquid material in which these minute electrically conductive particles are included, there is employed a dispersion, in which the minute electrically conductive particles are dispersed in a dispersion medium. The minute electrically conductive particles which are used here may be minute metallic particles which include any of gold, silver, copper, palladium, nickel, or the like, or may be minute particles of an electrically conducting polymer or of a superconducting material, or the like.

These minute electrically conductive particles may be used with a surface coating which is made from an organic material or the like, in order to enhance their dispersivity. As the coating material for coating the surfaces of these minute electrically conductive particles, for example, there may be cited a polymer such as one which induces steric hindrance or electrostatic repulsion. Furthermore, it is desirable for the diameter of the minute electrically conductive particles to be greater than or equal to 5 nm and less than or equal to 0.1 μm. This is because, if this diameter becomes greater than 0.1 μm, it becomes easy for blockage of the nozzles to occur, and ejection by an ink jet ejection method becomes difficult. Furthermore this is also because, if this diameter becomes less than 5 nm, then the volume proportion of the coating for the minute electrically conductive particles becomes relatively great, so that the proportion of organic material in the layer which is obtained becomes too great.

As the dispersion medium which includes these minute electrically conductive particles, it is desirable for it to be one whose vapor pressure at room temperature is greater than or equal to 0.001 mmHg and is less than or equal to 200 mmHg (greater than or equal to about 0.133 Pa and less than or equal to 26600 Pa). This is because, if the vapor pressure is greater than 200 mmHg, then, after the ejection, the dispersion medium evaporates abruptly, and it becomes difficult to form a layer of the desired good quality.

Moreover, it is desirable for the vapor pressure of the dispersion medium to be greater than or equal to 0.001 mmHg and is less than or equal to 50 mmHg (greater than or equal to about 0.133 Pa and less than or equal to 6650 Pa). This is because, if the vapor pressure is greater than 50 mmHg, then, when ejecting the liquid drops with an ink jet method (a liquid drop ejection method), it is easy for nozzle blocking to occur due to drying, and it becomes difficult to perform stable ejection. On the other hand, in the case of a dispersion medium whose vapor pressure at room temperature is less than 0.001 mmHg, the dispersion medium tends to remain in the layer which is formed, since it dries very slowly, and it becomes difficult to obtain an electrically conductive layer of good quality after processing with head and/or with light in the subsequent processes.

As the dispersion medium which is employed, it is not particularly limited, provided that is one in which is it possible to disperse the above described minute electrically conductive particles and in which no clumping occurs; apart from water, there may be suggested: alcohols such as methanol, ethanol, propanol, butanol, or the like; hydrocarbon type compounds such as n-pentane, n-octane, decane, toluene, xylene, cymene, durene, indene, dipentene, tetra-hydro-napthalene, deca-hydro-napthalene, cyclo-hexyl-benzene, or the like; ether type compounds such as ethylene glycol dimethyl-ether, ethylene glycol diethyl ether, ethylene glycol methyl-ethyl ether, diethylene glycol dimethyl-ether, diethylene glycol diethyl ether, diethylene glycol methyl-ethyl ether, 1,2-dimethoxy ethane, bis-(2-methoxy ethyl)ether, p-dioxane, or the like; or polar compounds such as propylene carbonate, γ-butyrolactane, N-methyl-2-pyrrolidone, dimethyl-formamide, dimethyl-sulfoxide, cyclo-hexanon, or the like. Among these, from the point of view of the dispersivity of the minute particles and the stability of the resultant dispersion liquid, and from the point of view of easy applicability to the ink jet method, water, alcohol type compounds, hydrocarbon type compounds, and ether type compounds are preferable; and as a more desirable dispersion medium, water or a hydrocarbon type compound are further preferred. These dispersion mediums may be employed individually, or as a mixture of two or more thereof.

The dispersion concentration when dispersing the above described minute electrically conductive particles in the dispersion medium should be greater than equal to 1% by mass and less than or equal to 80% by mass, and may be adjusted according to the thickness of the electrically conductive layer which is desired. When it becomes greater than 80% by mass, clumping can easily occur, and it is difficult to obtain an even layer.

It is desirable for the surface tension of the dispersion of the above described minute electrically conductive particles to be within the range of greater than or equal to 0.02 N/m and less than or equal to 0.07 N/m. This is because, when ejecting a liquid by the ink jet method, if the surface tension is less than 0.02 N/m, then spattering can easily occur, since the wettability with respect to the surfaces of the nozzles of the constituent material of the ink is great; while, if it is greater than 0.07 N/m, then it becomes difficult to control the amount of ejection and the timing of ejection, since the shape of the meniscus at the tip of the nozzle is not stable.

In order to adjust the surface tension, it is possible to add to the above described dispersion liquid a minute amount of a surface tension regulating substance such as one of a fluoro-type, a silicon type, or a non ionic type, within the range in which the angle of contact with the substrate is not inappropriately reduced. Such a non ionic type surface tension adjusting substance is one which serves the function of enhancing the wettability of the liquid with respect to the substrate, improving the leveling characteristic of the resultant layer, and preventing the generation of bubbling in the applied layer and the generation of irregular texture thereof and the like. The above described dispersion liquid may be, according to requirements, any organic compound such as an alcohol, an ether, an ester, a ketone, or the like.

It is desirable for the viscosity of the above described dispersion liquid to be greater than or equal to 1 mPa·s and less than or equal to 50 mPa·s. This is because, when ejecting a liquid with an ink jet method, if the viscosity is less than 1 mPa·s, then it is easy for the peripheral nozzle portions to become contaminated due to leakage of the ink, while, if the viscosity is greater than 50 mPa·s, then it is difficult to eject the liquid drops smoothly, because the frequency of clogging at the nozzle apertures becomes high.

In this preferred embodiment, the liquid drops of the above described dispersion liquid are ejected from the ink jet head and impinge upon the places upon the substrate where the wiring pattern is to be formed. At this time, it is necessary to control the amount of overlapping of the liquid drops which are continually ejected, so that pooling (accumulation) cannot occur. Furthermore, it is possible to employ an ejection method in which, in a first ejection episode, a plurality of liquid drops are ejected as mutually separated from one another so that they do not mutually connect together, and then, in a second ejection episode, the gaps between them are filled up.

Next (in the step S4) the first hardening process is performed upon the desired region of the tape shaped substrate 11 upon which the first liquid drop ejection process S3 has been performed.

This first hardening process S4 is a process which consists of a wiring material hardening process, in which the mass of liquid material which includes electrically conductive material which has been applied upon the tape shaped substrate by the first liquid drop ejection process S3 is hardened. By repeatedly performing the above described steps S3 and this step S4 (the step S2 may also be included), it is possible to increase the thickness of this layer, and it is possible thus to form a wiring pattern or the like of a desired shape and moreover of a desired layer thickness in a simple manner.

As a concrete example of this first hardening process, there may be cited, for example, a method of hardening the mass of liquid material which has been applied to the tape shaped substrate 11 by drying it, and, in more concrete terms, by hardening it by irradiation with UV light. As another concrete example of this first hardening process S4, for example, it may be performed by heating up the tape shaped substrate with a hot plate, or by processing it in an electric oven or the like, or by subjecting it to lamp annealing. As the light source which may be used for lamp annealing, this is not to be considered as being particularly limited; it is possible to utilize a light source such as an infrared lamp, a xenon lamp, a YAG laser, an argon laser, a carbon dioxide gas laser, or an excimer laser such as a XeF, XeCl, XeBr, KrF, KrCl, ArF, or ArCl laser or the like. Although these types of light source are generally utilized in the output range from 10 W to 5000 W, for the preferred embodiments of the present invention, it is considered that the range of 100 W to 1000 W will be sufficient.

Next (in the step S5) the second liquid drop ejection process S5, which consists of a process of application of an insulating material, is performed upon the desired region of the tape shaped substrate 11, upon which the above described first hardening process S4 has been performed.

The liquid drop ejection by this second liquid drop ejection process S5 is performed by a liquid drop ejection device 20 like the one shown in FIG. 2 as well. However, it is desirable for the liquid drop ejection device 20 which is used in the first liquid drop ejection process S3 to be a separate device from the liquid drop ejection device 20 which is used in the second liquid drop ejection process S5. By making them be separate devices, it is possible to perform the first liquid drop ejection process S3 ad the second liquid drop ejection process S5 at the same time, and it is thereby possible to anticipate faster manufacturing and an enhancement of the operational ratio of the liquid drop ejection devices.

The second liquid drop ejection process S5 is a process in which a mass of liquid material which is endowed with the characteristic of being electrically insulating is applied by the liquid drop ejection device as an upper layer over the wiring layer which has been formed upon the tape shaped substrate 11 by the first liquid drop ejection process S3 and the first drying process S4. In other words, a mass of liquid material which is electrically insulating is applied all over a predetermined region of the tape shaped substrate, by using the liquid drop ejection device 20. By this process, an insulating layer is formed over the wiring pattern which has been formed by the first liquid drop ejection process S3 and the first hardening process S4. Before performing this second liquid drop ejection process, it is desirable to perform surface processing which corresponds to the surface processing process of the above described step S2. In other words, it is desirable to perform lyophilization processing for the entire predetermined region of the tape shaped substrate 11.

Next (in the step S6) the second hardening process S6 is performed upon the desired region of the tape shaped substrate 11 upon which the second liquid drop ejection process S5 has been performed.

This second hardening process S6 is an insulating material hardening process in which the in which the mass of electrically insulating material which has been applied upon the tape shaped substrate 11 by the second liquid drop ejection process S5 is hardened. As a concrete example of this second hardening process S6, there may be cited, for example, a method of hardening this mass of liquid material which has been applied upon the tape shaped substrate 11 by drying it, and in more concrete terms, there may be suggested a method of hardening it by UV irradiation. By repeatedly performing the above described steps S5 and S6 (a surface processing process may also be included), it is possible to form a layer which is thick, and it is possible to form an insulating layer of the desired shape and moreover of the desired thickness and the like in a simple manner. As a concrete example of this second drying process S6, the same example may be considered as the concrete example of the first drying process S4.

The above described steps S2 through S6 constitute a first wiring layer formation process A in which a first wiring layer is formed. It is possible to form a second wiring layer over the first wiring layer after this first wiring layer formation process, by repeating the performance of the above described steps S2 through S6. This process of forming the second wiring layer constitutes a second wiring layer formation process B. It is possible to form yet a third wiring layer over this second wiring layer after this first wiring layer formation process, by repeating the performance of the above described steps S2 through S6 again. This process of forming the third wiring layer constitutes a third wiring layer formation process C. By repeating the performance of the above described steps S2 through S6 yet again, it is possible to form as many further layers of wiring pattern upon the tape shaped substrate 11 as desired, in a simple and yet suitable manner.

Next (in the step S7), after having formed a first wiring layer, a second wiring layer, and a third wiring layer by performing the above described steps S2 through S6 repeatedly, the firing process S7 is performed upon the desired region of this tape shaped substrate 11.

This firing process S7 is a process in which the wiring layers which have been subjected to drying processing after having been applied by the first liquid drop ejection process S3 and the insulating layers which have been subjected to drying processing after having been applied by the second liquid drop ejection process S5 are fired all together. The electrical contact between the minute particles of the wiring pattern in the wiring patterns upon the tape shaped substrate 11 is ensured by this firing process S7, and these wiring patterns are converted into electrically conductive layers. Furthermore, the insulating characteristic of the insulating layers upon the tape shaped substrate 11 are enhanced by this firing process S7.

This firing process S7 may be performed in a normal atmosphere, or, according to requirements, may be performed in an inert gas atmosphere such as one of nitrogen, argon, helium, or the like. The processing temperature for this firing process S7 is determined appropriately, in consideration of the boiling point (the vapor pressure) of the dispersion medium which was included in the masses of liquid material which were applied in the first liquid drop ejection process S3 and the second liquid drop ejection process S5, and in consideration of the type and pressure of the ambient gas, the thermal behavior of the dispersivity, the oxidizability and the like of the minute particles, the presence or absence of coating material and its thickness if present, and the heat resistance of the base material and the like. For example, in the firing process S7, the desired region of the tape shaped substrate 11 may be fired at 150° C.

This type of firing processing may be performed by processing with a normal type of hot plate or electric oven or the like, and may also be performed by lamp annealing. As the light source which may be used for lamp annealing, this is not to be considered as being particularly limited; it is possible to utilize a light source such as an infrared lamp, a xenon lamp, a YAG laser, an argon laser, a carbon dioxide gas laser, or an excimer laser such as a XeF, XeCl, XeBr, KrF, KrCl, ArF, or ArCl laser or the like. Although these types of light source are generally utilized in the output range from 10 W to 5000 W, it is considered that, for these preferred embodiments of the present invention, the range of from 100 W to 1000 W will be sufficient.

Since by doing this, according to these preferred embodiments of the present invention, a wiring pattern is formed using a liquid drop ejection method upon the tape shaped substrate 11, which is a reel to reel substrate, accordingly it is possible to manufacture an electronic substrate with this wiring pattern upon it with good efficiency and in large quantities. In other words, according to these preferred embodiments of the present invention, during component production, by aligning desired regions of the single tape shaped substrate 11, which constitutes a large scale plate shaped substrate, suitably to the desired position of the liquid drop ejection device 20, it is possible to form the desired wiring patterns in these desired regions. Thus, after having formed a patterns in one of the desired regions with the liquid drop ejection device 20, by moving the tape shaped substrate 11 with respect to the liquid drop ejection device, it becomes possible to form another wiring pattern in another one of the desired regions on the tape shaped substrate 11 in an extremely simple manner. By doing this, in these preferred embodiments of the present invention, it is possible to form wiring patterns in a simple and moreover a quick manner in the various desired regions (the various circuit substrate regions) of the tape shaped substrate 11, which is a reel to reel substrate, and it is possible to perform manufacture of wiring patterns upon the substrate and the like on a large scale with good efficiency.

By doing this, according to these preferred embodiments of the present invention, the plurality of processes including the liquid drop application process, described above, are executed upon the tape shaped substrate 11, which is a reel to reel substrate, from when it is unwound from the first reel 101, to when it is wound up upon the second reel 102. Due to this, it is possible to shift this tape shaped substrate 11 from the device which executes the cleansing process S1 to the device which executes the surface processing process S2, and to the devices which execute the subsequent processes, merely by winding up the one end of the tape shaped substrate 11 with the second reel 102. Thus, according to these preferred embodiments of the present invention, it is possible to simplify the transport mechanism and the alignment mechanism for shifting the tape shaped substrate 11 to each device for each process, and it is possible to reduce the space required for setting up the manufacturing device, and to reduce the cost of manufacture for large scale production or the like.

Furthermore, with this preferred embodiment of the pattern formation system and the pattern formation method of the present invention, it is desirable for the time which is occupied by each of the above described plurality of processes to be almost the same. If matters are arranged in this manner, then it is possible to execute each of these processes simultaneously in parallel, and, along with it being possible to perform the manufacture more quickly, it is also possible to increase the utilization ratio of each device for each of the processes. Here, in order to make the time which is required for each of the processes uniform, it would also be acceptable to adjust the number and/or the performance of the devices (for example, the liquid drop ejection device 20) which are used for each of the processes. For example, if the second liquid drop ejection process S5 comes to occupy a longer period of time than does the first liquid drop ejection process S3, then it would be acceptable to utilize a single liquid drop ejection device 20 for the first liquid drop ejection process S3, and to utilize two liquid drop ejection devices 20 for the second liquid drop ejection process S5.

The Liquid Drop Ejection Device

Next the liquid drop ejection device 20 will be explained in concrete terms with reference to the drawings. As shown in FIG. 2, this liquid drop ejection device comprises an ink jet head group (an ejection head) 1, an X direction guide shaft 2 (a guide) for driving the ink jet head group 1 in the X direction, and a X direction drive motor 3 which rotates the X direction guide shaft 2. Furthermore, this liquid drop ejection device 20 comprises a mounting table 4 for mounting the tape shaped substrate 11, a Y direction guide shaft 5 (a guide) for driving the mounting table 4 in the Y direction, and a Y direction drive motor 6 which rotates the Y direction guide shaft 5. Yet further, this liquid drop ejection device comprises a main stand 7 upon which the X direction guide shaft 2 and the Y direction guide shaft 5 are fixed in predetermined positions, and a control device 8 fitted underneath this main stand 7. Even further, this liquid drop ejection device 20 comprises a cleaning mechanism section 14 and a heater 15.

Here, the X direction guide shaft 2, the X direction drive motor 3, the Y direction guide shaft 5, the Y direction drive motor 6, and the mounting table 4 constitute a head shifting mechanism which shifts the ink jet head group 1 relatively with respect to the tape shaped substrate 11 which has been aligned upon said mounting table 4. Furthermore, during the operation of ejecting liquid drops from the ink jet head group 1, the X direction guide shaft 2 shifts the ink jet head group 1 in the direction (the X direction) which intersects at substantially a right angle with the lengthwise direction of the tape shaped substrate 11 (the Y direction).

The ink jet head group 1 comprises a plurality of ink jet heads which supply a dispersion liquid (a mass of liquid material) including, for example, minute electrically conductive particles, by ejecting said liquid from nozzles (ejection apertures) at predetermined intervals against the tape shaped substrate 11. Each of this plurality of ink jet heads is arranged to be able to eject the dispersion liquid individually, according to an ejection voltage which is outputted from the control device 8. The ink jet head group 1 is fixed to the X direction guide shaft 2, and the X direction drive motor 3 is connected to the X direction guide shaft 2. The X direction drive motor 3 is a stepping motor or the like, and it is arranged for the X direction guide shaft 2 to be rotated, when a drive pulse signal for the X axis direction is supplied from the control device 8. It is arranged for the ink jet head group 1 to be shifted along the X axis direction with respect to the main stand 7, when the X direction guide shaft 2 is rotated.

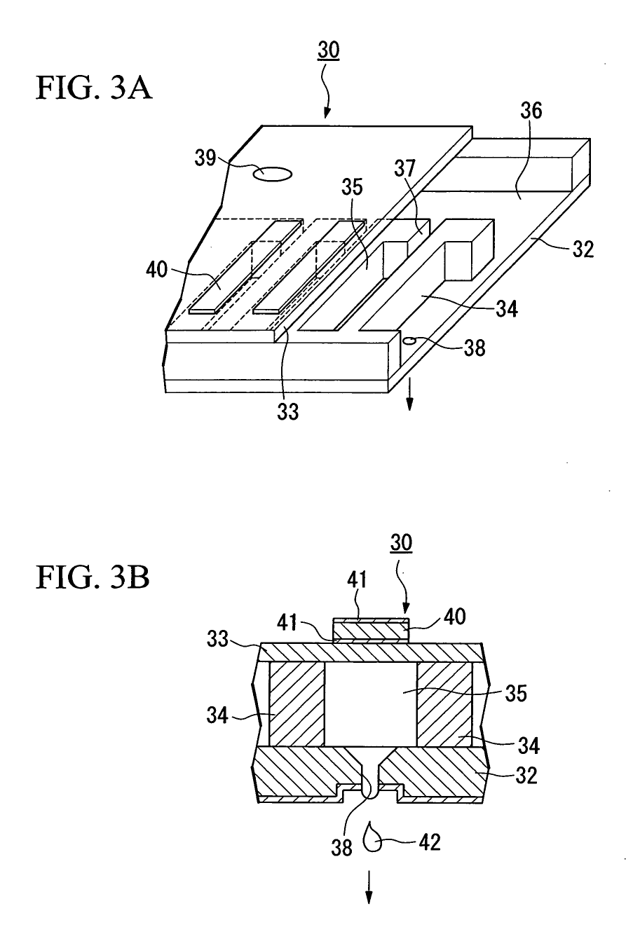

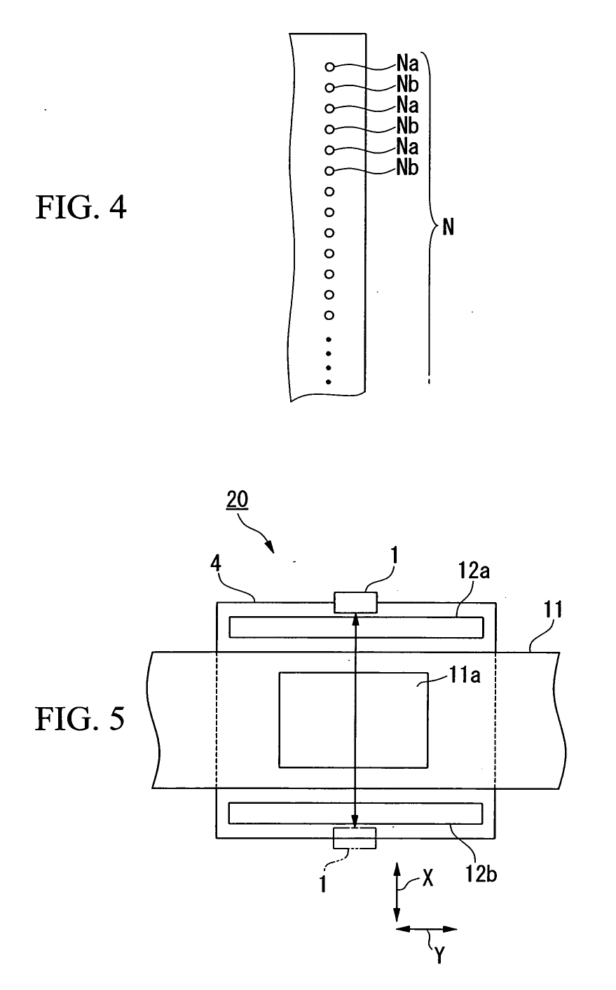

The details of the plurality of ink jet heads which make up the ink jet head group 1 will now be explained. FIGS. 3A and 3B are figures showing one of these ink jet heads 30. FIG. 3A is a general perspective view of essential elements of the ink jet head 30, while FIG. 3B is a sectional view thereof. FIG. 4 is a bottom view of this ink jet head 30.

As shown in FIG. 3A, the ink jet head 30 comprises a nozzle plate 32 and a vibration plate 33 which are made, for example, from stainless steel, and these two elements are connected together via a partition member (reservoir plate) 34. A plurality of empty spaces 35 and a liquid storage tank 36 are defined by the partition member 34 between the nozzle plate 32 and the vibration plate 33. The liquid material (the ink) which is to be ejected is filled into the empty spaces 35 and the storage tank 36, and it is arranged for each of the empty spaces to be communicated to the storage tank 36 via a supply aperture 37. Furthermore, a plurality of nozzle apertures 38 for ejecting the mass of liquid material from the empty spaces 35 are formed in the nozzle plate 32, and are arranged horizontally and vertically upon it. On the other hand, an aperture 39 is formed in the vibration plate 33 for supply of the liquid material into the storage tank 36.

Furthermore, as shown in FIG. 3B, piezoelectric elements (piezo elements) 40 are attached upon the opposite side of the vibration plate 33 to its surface which confronts the empty space 35, i.e. upon its upper surface. Each of these piezoelectric elements 40 is positioned between a pair of electrodes 41, and said piezoelectric element 40 is arranged to deform so as to project outwards, when electrical power is supplied to said electrodes 41. Based upon this type of structure, the vibration plate 33 to which this piezoelectric element 40 is attached is arranged to flex toward the outside at the same time, as a unit together with the piezoelectric element 40, and thereby it is arranged for the volume of the empty space 35 to be increased. Accordingly, a mass of liquid material which corresponds to the amount by which the volume within the empty space 35 has increased is sucked in via the supply aperture 37. Furthermore, when from this state the electrical supply to the piezoelectric element 40 is cut off, the piezoelectric element 40 and the vibration plate 33 both return back to their original states. Accordingly, since the empty space 35 also returns back to its original volume, the pressure of the mass of liquid material within the empty space 35 rises, and a certain quantity thereof is ejected as a liquid drop 42 towards the substrate from the nozzle aperture 38.

It should be understood that, while the bottom surface shape of the ink jet head 30 which has this type of structure is generally rectangular, as shown in FIG. 4, the nozzles N (the nozzle apertures 38) are arranged rectangularly in the state of being spaced at equal intervals in the vertical direction. In this embodiment, in the row of nozzles which are arranged along its lengthwise direction, in other words in its vertical direction, every second nozzle among the plurality of nozzles is taken as being a main nozzle (a first nozzle) Na, while the nozzles which are positioned between these main nozzles Na are taken as being auxiliary nozzles (second nozzles) Nb.

An individual piezoelectric element 40 is provided for each of this plurality of nozzles N (the nozzles Na and Nb), and thereby it is arranged for their ejection operations to be controlled individually. In other words, by controlling the ejection waveform for the electrical signal which is dispatched to this type of piezoelectric element 40, it is arranged for it to be possible to adjust and to vary the ejection amounts of the liquid drops from these nozzles N. Here, this type of control of the ejection waveform is arranged to be performed by the control device 8, and, based upon this type of structure, it is arranged to endow the control device 8 with the function of serving as an ejection amount adjustment means for varying the liquid drop ejection amount from each of the nozzles N.

It should be understood that, as the type for this ink jet head 30, it is not limited to being a piezo jet type which uses such a piezoelectric element 40; for example, it would also be possible to employ a thermal type device, and, in this case, it would be possible to vary the volume of the liquid drop ejection by arranging to vary the time period of application.

Returning to FIG. 2, the mounting table 4, upon which the tape shaped substrate 11 to which the dispersion liquid is to be applied by this liquid drop ejection device 20 is mounted, is provided with a mechanism for fixing this tape shaped substrate 11 in a standard position (i.e. an alignment mechanism). The mounting table 4 is fixed to the Y direction guide shaft 5, and Y direction drive motors 6 and 16 are connected to this Y direction guide shaft 5. These Y direction guide motors 6 and 16 are stepping motors or the like, and it is arranged, when a drive pulse signal for the Y axis direction is supplied from the control device 8, for the Y direction guide shaft 5 to be rotated. It is arranged, when the Y direction guide shaft 5 is rotated, for the mounting table 4 to be shifted in the Y axis direction with respect to the main stand 7.

The liquid drop ejection device 20 comprises a cleaning mechanism section 1 for cleaning the ink jet head group 1. This cleaning mechanism section 14 is arranged to be shifted along the Y direction guide shaft by the Y direction drive motor 16. This shifting of the cleaning mechanism section 14 is also controlled by the control device 8.

Next, flushing areas 12a and 12b for the liquid drop ejection device 20 will be explained.

FIG. 5 is a partial plan view showing the vicinity of the ink jet head group 1 of the liquid drop ejection device 20. Furthermore, two flushing areas 12a and 12b are provided upon the mounting table 4 of the liquid drop ejection device 20. These flushing areas 12a and 12b are regions which are arranged at both sides of the shorter direction (the X direction) of the tape shaped substrate 11, and they are regions to which the ink jet head group 1 can be shifted by the X direction guide shaft 2. In other words, the flushing areas 12a and 12b are arranged at both the sides of a desired region 11a, which is a region which corresponds to a single circuit substrate upon the tape shaped substrate 11. These flushing areas 12a and 12b are regions in which some of the dispersion liquid (i.e., parts of the mass of liquid material) from the ink jet head group 1 is discarded. By arranging the flushing areas 12a and 12b in this manner, it is possible to shift the ink jet head group 1 quickly to one or the other of these flushing areas 12a and 12b. For example, if the ink jet head group 1 comes to be in a state in which flushing is desired while it is positioned near the flushing area 12b, then the ink jet head group 1 is not shifted to the flushing area 12a which is comparatively far away, but rather is shifted to the flushing area 12b which is comparatively close, and thereby it is possible to perform the flushing relatively quickly.

Returning to FIG. 2, a heater 15 is a means for heat processing (drying processing or firing processing) the tape shaped substrate 11 by, here, lamp annealing. In other words the heater 15, along with being able to perform evaporation and drying of the mass of liquid material which has been ejected upon the tape shaped substrate 11, also is able to perform heat processing for converting it into an electrically conductive layer. The turning on and off of power to this heater 15 is also arranged to be controlled by the control device 8.

With the liquid drop ejection device 20 of this first preferred embodiment, in order to eject the dispersion liquid upon the prescribed wiring pattern formation region, predetermined drive pulse signals are supplied from the control device 8 to the X direction drive motor 3 and/or to the Y direction drive motor 6, and thereby the ink jet head group 1 and/or the mounting table 4 are shifted, so that the ink jet head group 1 and the tape shaped substrate 11 (the mounting table 4) are shifted relatively to one another. During this relative shifting, predetermined ejection voltages are supplied from the control device 8 to the ink jet heads 30 of the ink jet head group 1, so that the dispersion liquid is ejected from said ink jet heads 30.

With the liquid drop ejection device 20 of this first preferred embodiment, the ejection amount of the liquid drops from the ink jet heads 30 of the ink jet head group 1 may be adjusted by varying the ejection voltages which are supplied from the control device 8. Furthermore, the pitch of the liquid drops which are ejected upon the tape shaped substrate 11 is determined by the relative shifting speed of the ink jet head group 1 and the tape shaped substrate 11 (the mounting table 4) and the ejection frequency from the ink jet head group 1 (i.e. by the frequency of the ejection voltages which are supplied).

According to the liquid drop ejection device 20 of this first preferred embodiment of the present invention, by shifting the ink jet head group 1 along the X direction guide shaft 2 or along the Y direction guide shaft 5, it is possible to form the desired pattern by adhering the liquid drops in the desired positions in the desired regions of the tape shaped substrate 11. After having formed a desired pattern in a single desired region, by shifting the tape shaped substrate 11 along its lengthwise direction (the Y direction), it is possible to form patterns in other ones of the desired regions extremely simply and easily. Here, it is possible for one desired region to correspond to a single circuit substrate. Thus, with this first preferred embodiment of the present invention, it is possible to form a desired pattern simply and moreover at high speed upon each of the desired regions (i.e. upon each of the circuit substrate regions) of the tape shaped substrate 11, and it is possible to manufacture a wiring pattern or an electronic circuit or the like with good efficiency and moreover in large quantity.

Furthermore, with the pattern formation system of this first preferred embodiment of the present invention, it is desirable to provide a structure in which this tape shaped substrate 11 is wound up upon the second reel 102, so that the surface of the tape shaped substrate 11 upon which the mass of liquid material has been applied by the liquid drop ejection device 20 faces towards the inside. Yet further, it is desirable for the inner surface of the tape shaped substrate which is wound up on the first reel 101 to be its surface upon which the mass of liquid material is applied by the liquid drop ejection device 20.

Since, when matters are arranged in this manner, this tape shaped substrate 11 is wound up upon the second reel 102 with the surface of the tape shaped substrate 11 upon which the patterns are formed facing towards the inside, accordingly it becomes possible to ensure that the resulting patterns are preserved in a suitable state, just as they are. Moreover, since the directions in which the tape shaped substrate 11 is bent around the first reel 101 and around the second reel 102 are the same, accordingly it is possible to reduce the action of external mechanical forces upon the tape shaped substrate 11, so that it is possible to reduce the deformation and the like of said tape shaped substrate 11.

Furthermore, with the pattern formation system of this first preferred embodiment of the present invention, it would also be acceptable to arrange for the liquid drop ejection device 20 to be provided with one or a plurality of ink jet head groups 1 which were able to eject liquid drops at almost the same time upon the front surface and the rear surface of the tape shaped substrate 11. For such a type of liquid drop ejection device 20, a structure may be applied which holds the surface of the tape shaped substrate 11 in a vertical state, and in which respective ink jet head groups 1 are provided at the front surface side and at the rear surface side of this tape shaped substrate 11. With this type of structure, it is possible to form thin film patterns upon both the front and the rear surface of the tape shaped substrate 11 at the same time, and, moreover, it is possible to implement shortening of the manufacturing time and reduction of the cost of manufacture.

Furthermore, with the pattern formation system of this first preferred embodiment of the present invention, it would also be acceptable to provide a reversing mechanism (not shown in the figures) which twisted the tape shaped substrate 11 so as to reverse its front surface and its rear surface. It would be desirable to provide, to the liquid drop ejection device 20, a first ink jet head group (a first ejection head) which ejects liquid drops upon the upper side surface of the tape shaped substrate 11 before it is twisted round by the reversing mechanism, and a second ink jet head group (a second ejection head) which ejects liquid drops upon the (newly) upper side surface of the tape shaped substrate 11 after it has been twisted round by the reversing mechanism.

According to this type of structure, it is possible to reverse the tape shaped substrate 11 with the reversing mechanism, so that it is possible to apply liquid drops to a one surface of the tape shaped substrate 11 with the first ink jet head group, and then it is possible to apply liquid drops to the other surface of the tape shaped substrate 11 with the second ink jet head group. Accordingly, it is possible to apply the mass of the liquid material to both the surfaces of the tape shaped substrate 11 by using this liquid drop ejection method.

### The Second Preferred Embodiment

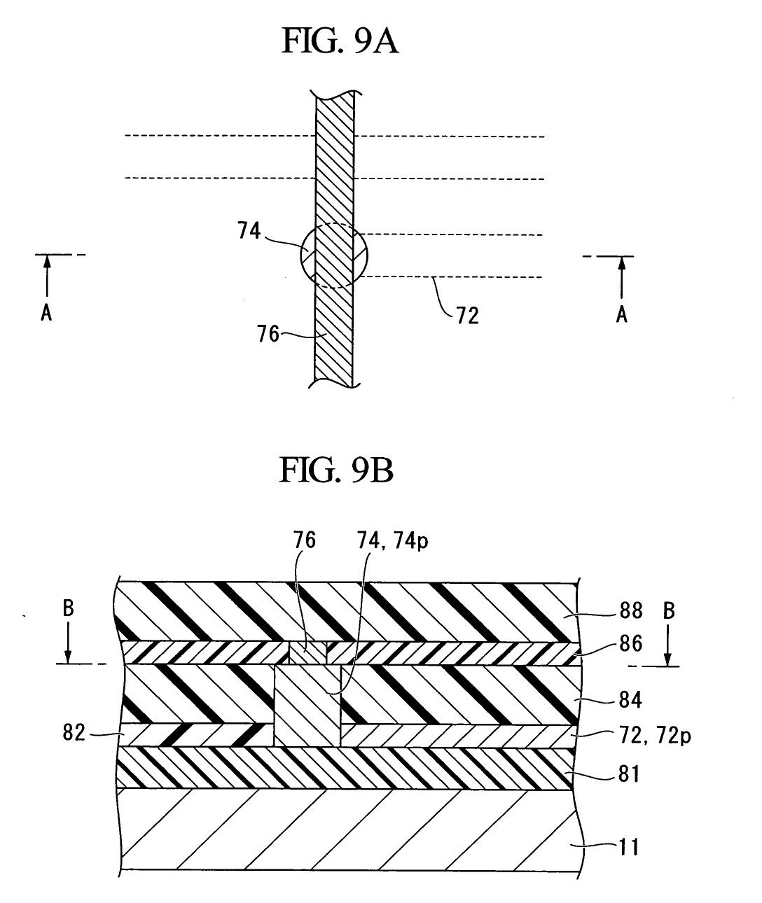

Next, a pattern formation method according to the second preferred embodiment of the present invention will be explained using FIGS. 7 through 11. It should be understood that, for portions which are the same as in the first preferred embodiments, the detailed description will be omitted.

FIG. 7 is an explanatory figure for this pattern formation method according to the second preferred embodiment. In the pattern formation method according to the first preferred embodiment of the present invention described above, the plurality of processes which included said liquid drop application process by said liquid drop ejection method were executed from unwinding said reel to reel substrate until winding it up. By contrast, in this second preferred embodiment of the present invention, only from one to a few of these processes are executed from unwinding said reel to reel substrate until winding it up. In this case, it is possible to simplify the pattern formation system. Furthermore if, for these processes, only a single process of alignment is performed, then, since it becomes possible to perform processing for a plurality of desired regions which are included upon the reel to reel substrate, accordingly the merit is obtained that high productivity of components like wiring substrates or the like can be obtained.

For this, in the pattern formation method according to the second preferred embodiment, after having completed the process of wiring material application with the liquid drop ejection device 20, and before hardening the mass of liquid material which has been applied, it is arranged to wind up the tape shaped substrate 11. This point could also be considered in the case of winding on of the tape shaped substrate 11 after having formed the wiring by hardening the mass of liquid material which has been applied. However, in this case, there is the problem that, in accompaniment with bending of the tape shaped substrate, cracks may appear in the wiring, or abrasion of the wiring may occur. (It should be understood that, if the tape shaped substrate is wound up after the surface of the wiring has been covered with the insulation material as in the first preferred embodiment, this type of problem does not occur.) By contrast, since it is possible to be gentle with the bending of the tape shaped substrate 11 before the mass of liquid material has hardened, accordingly it is possible to prevent the generation of cracks in the wiring or abrasion or the like thereof. Therefore it is possible to form the pattern with excellent reliability.

It should be understood that, if the mass of liquid material before hardening is endowed with flowability, then there is a danger than, merely by winding up the tape shaped substrate, the mass of liquid material may deform by flowing. In this case, it is desirable to prevent deformation of the mass of liquid material due to flowing by winding up the tape shaped substrate after having tentatively dried the mass of liquid material to an extent which eliminates the flowability of said liquid material. This tentative drying may be performed by blowing a drying gas, such as air whose humidity is low or a non volatile gas or the like, against the mass of liquid material. The temperature of this drying gas may be normal room temperature (about 25° C.), or may be an elevated temperature. Moreover, instead of blowing this drying gas against the liquid material mass, an infrared lamp or the like may be employed, and the mass of liquid material may be irradiated thereby. Since, by utilizing blowing of drying gas or irradiation by infrared as a concrete method for tentative drying in this manner, it is possible to perform tentative drying with simple manufacturing facilities and by a simple manufacturing process, accordingly it is possible to suppress increase of the cost of facilities and of the cost of manufacture. Furthermore, even if the temporary temperature for tentative drying is elevated, since the workpiece is immediately returned to normal temperature, accordingly it is possible to shorten the manufacturing time.

On the other hand, if the tape shaped substrate 11 is wound up before the mass of liquid material which has been applied hardens, then the mass of liquid material is crushed against the rear surface of the tape shape substrate which has already been wound up, and it becomes impossible to form the desired pattern. Thus, in this pattern formation method according to the second preferred embodiment of the present invention, it is arranged to wind up the tape shaped substrate 11 in the state in which a tape shaped spacer 91 is interposed so as to cover the application region of the mass of liquid material upon said tape shaped substrate 11. In concrete terms, the tape shaped spacer 91 (hereinafter simply termed a “spacer”) is fed out from a spacer reel 90, and this spacer 91 is laid along the surface of the tape shaped substrate 11 by an installation roller 98. The spacer 91 and the tape shaped substrate 11 are wound up onto the second reel 102 in the state of being laid against one another and mutually superimposed.

FIG. 8 is an explanatory figure for the process of laying the spacer 91 against the surface of the tape shaped substrate 11. The spacer 91 is made in the form of a film from a resin material such as a polyimide or the like. The central portion of this spacer 91 in the widthwise direction is made as a flat surface, but a concave and convex portion 92 is formed at both its end portions in the widthwise direction. These concave and convex portions 92 may be formed by heating and pressing the spacer 91 using a mold which has the opposite shape to them. Convex portions 94 are formed by these concave and convex portions 92 upon the surface of, at least, the sides of the tape shaped substrate 11. These convex portions 94 are formed at equal intervals along the lengthwise direction of the tape shaped substrate 11. In addition to this, it would also be acceptable to form convex portions upon the side of the spacer 91 which is opposite to the tape shaped substrate 11, and it would be desirable for the height of these convex portions to be less than the height of the convex portions 94 on the side of the tape shaped substrate 11.

When placing the spacer 91 against the surface of the tape shaped substrate 11, the convex portions 91 which are formed upon the surface of the spacer 91 fit into regions upon the tape shaped substrate 11 which lie outside the application region 11a for the mass of liquid material. In this second preferred embodiment of the present invention, this application region 11a for the mass of liquid material is set to be in the central portion of the tape shaped substrate in its widthwise direction, and, since the convex portions 94 are formed at both end portions of the spacer 91 in its widthwise direction, accordingly it is possible to make the convex portions 94 of the spacer 91 to contact against regions upon the tape shaped substrate 11 other than the application region 11a for the mass of liquid material. As a result, it is possible to cover the application region 11a upon the tape shaped substrate 11 for the mass of liquid material with the flat portion at the central portion of the spacer 91 in its widthwise direction. Due to this, it becomes possible to prevent contact between the mass of liquid material which has been applied and the exterior, and it is possible to form the desired pattern while protecting the mass of liquid material.

It should be understood that holes (perforations) 11b are formed at equal intervals at both end portions of the tape shaped substrate 11 in its widthwise direction, for winding up the tape shaped substrate 11. These winding up holes 11b are holes into which pins (not shown in the figures) on the winding up reel for the tape shaped substrate are engaged. Since, when this winding up reel is rotated through just a predetermined angle, a predetermined number of these winding up holes are engaged with the predetermined number of the pins which are provided over this predetermined angle, accordingly it is arranged for it to be possible to wind up a predetermined length of the tape shaped substrate 11 accurately. In this second preferred embodiment of the present invention, the convex portions 94 which are formed at both ends of the spacer 91 in its widthwise direction are engaged with these winding up holes 11b in the tape shaped substrate 11. For this, the spacer 91 is formed so that the pitch of the convex portions 94 upon the spacer 91 is the same as the pitch of the winding up holes 11b upon the tape shaped substrate 11. By engaging the convex portions 91 of the spacer 91 into the winding up holes 11b in the tape shaped substrate 11, it is possible to prevent relative positional slippage between the tape shaped substrate 11 and the spacer 91. By doing this, it is possible reliably to protect the application region for the mass of liquid material upon the tape shaped substrate 11.

The tape shaped substrate which has been wound up together with the spacer is conveyed to the subsequent process in the state of a reel to reel substrate. In this subsequent process, the tape shaped substrate is unwound from the first reel, along with stripping off the spacer from the surface of said tape shaped substrate and winding it up onto a spacer reel. From winding the tape shaped substrate off to winding it up, processes at least from the process of forming the wiring which has been hardened by firing the mass of liquid material to the process of coating the surface of this wiring with an inter-layer insulating layer are performed. If the surface of the wiring which has been hardened is coated with an inter-layer insulating layer in this manner, then, without greatly deforming the wiring along with the bending of the tape shaped substrate, it is possible to prevent the generation of cracks or abrasions in the wiring.

It should be understood that this pattern formation method by the reel to reel method can be applied to a substrate which is endowed with flexibility, such as a flexible printed circuit substrate (Flexible Printed Circuit—hereinafter termed a “FPC”) or the like. Since, in this case, the tape shaped substrate 11 is subjected to very great bending, when the tape shaped substrate 11 is wound up after the wiring has been hardened, there is a substantial danger that cracking or abrasion of the wiring may occur. Accordingly the benefits of the second preferred embodiment of the present invention described above are particularly conspicuous when forming a wiring pattern upon a FPC with the pattern formation method.

A Wiring Pattern

Next, an example of a wiring pattern which is formed using this liquid drop ejection method will be explained.

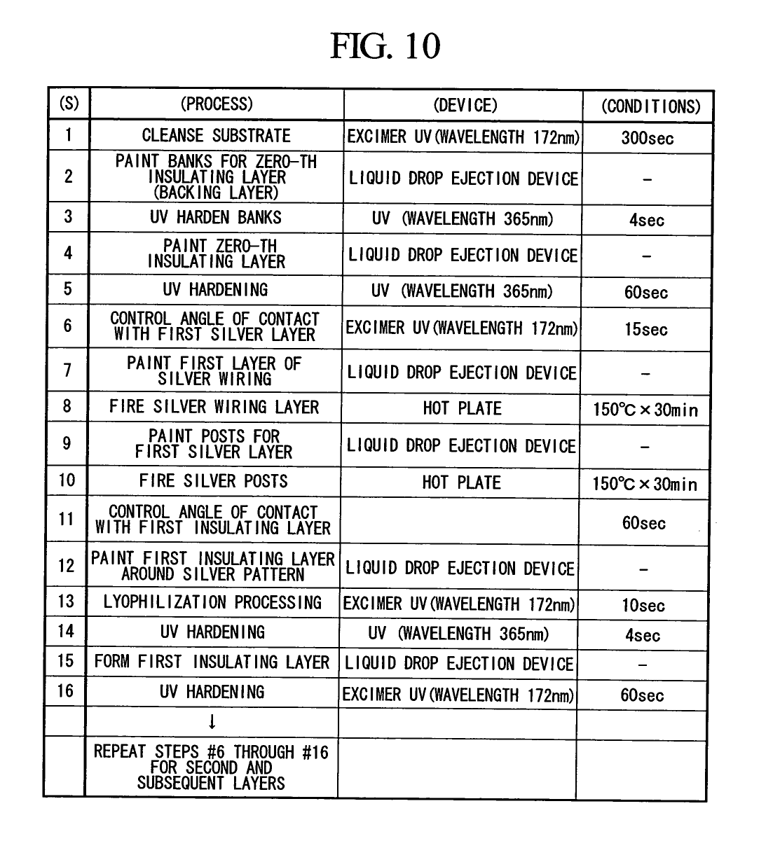

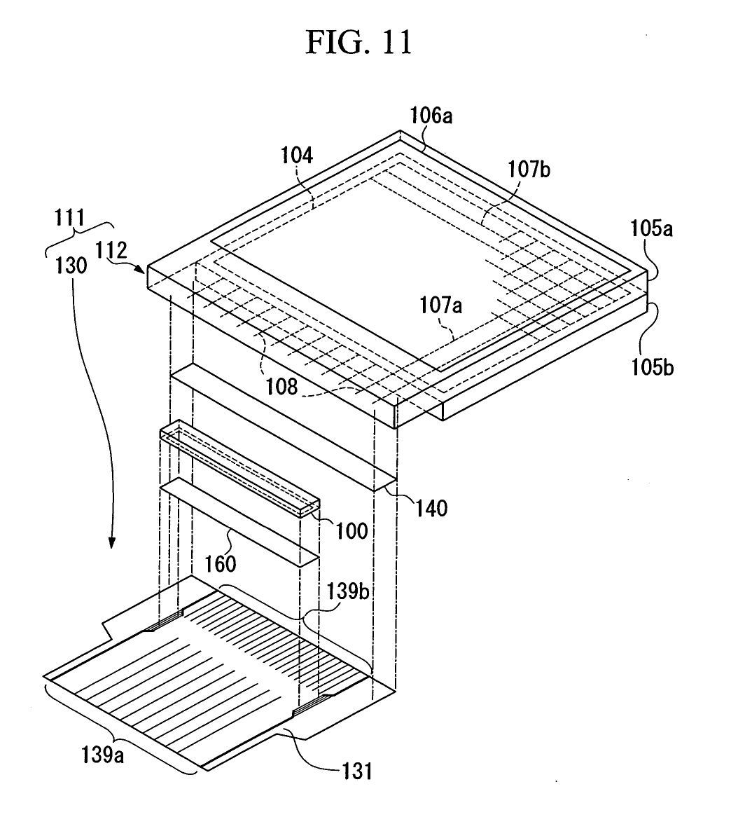

FIGS. 9A and 9B are explanatory figures for this exemplary wiring pattern. It should be understood that FIG. 9A is a sectional plan view as viewed along the lines B-B in FIG. 9B, while FIG. 9B is a sectional side view as viewed along the lines A-A in FIG. 9A. In the wiring pattern shown in FIG. 9B, along with the electrical wires 72 in the lower layer and the electrical wiring 76 in the upper layer being laid over one another with the interposition of an inter-layer insulating layer 84, they are also connected together at appropriate points by electrically conducting posts 74 so that electrical current can flow between them. It should be understood that the wiring pattern which is explained below is only an example, and it would be possible to apply the present invention to various other wiring patterns as well.

The wiring pattern shown in FIG. 9B is formed upon the surface of the tape shaped substrate 11 previously described. A backing insulating layer 81 is formed upon the surface of this tape shaped substrate 11. This backing insulating layer 81 is made from an electrically insulating material which has, as its principal component, a resin which can be hardened by illumination with ultraviolet light, such as an acrylic resin or the like.

A plurality of electrical wires 72 are formed upon the surface of this backing insulating layer 81. These electrical wires 72 are made in a predetermined pattern from an electrically conductive material such as Ag (silver) or the like. It should be understood that an intra-layer insulating layer 82 is formed upon the surface of the backing insulating layer 81, in the regions in which the electrical wires 72 are not formed. By employing a liquid drop ejection method, the line x space of the electrical wires 72 can be miniaturized to, for example, 30 μm×30 μm.

Furthermore, an inter-layer insulating layer 82 is formed so as mainly to cover the electrical wires 72. This inter-layer insulating layer 84 is also made from the same resin material as the backing insulating layer 81. An electrically conducting post 74 is formed, projecting upwards from the end portion of an electrical wire 72, of an appropriate height to pass through the inter-layer insulating layer 84. This electrically conducting post 74 is made in the shape of a pillar from an electrically conductive material which is the same as that which is used for the electrical wires 72, such as Ag or the like. As an example, the thickness of the electrical wires 72 may be about 2 μm, and the height of the electrically conducting post 74 may be made to be about 8 μm.

An upper layer of electrical wiring 76 is formed upon the surface of this inter-layer insulating layer 84. This upper layer of electrical wiring 76 is also made from an electrically conductive material which is the same as that which was used for the electrical wiring 72 of the lower layer, such as silver (Ag) or the like. It should be understood that, as shown in FIG. 9(a), the electrical wiring 76 upon this upper layer may be arranged so as to intersect with the electrical wiring 72 upon the lower layer. This electrical wiring 76 upon the upper layer is connected to the upper end portion of the electrically conducting post 74, and thereby an electrically conductive connection with the lower layer of electrical wiring 72 is assured.

Yet further, as shown in FIG. 9B, an intra-layer insulating layer 86 is formed in the regions upon the surface of the inter-layer insulating layer 84 where the upper layer of electrical wiring 76 is not formed. Furthermore, a protective layer 88 is formed so as mainly to cover the upper layer of electrical wiring 76. This intra-layer insulating layer 86 and protective layer 88 are also made from the same resin material as was the backing insulating layer 81.

Although, in the above discussion, the case of a wiring pattern comprising two layers of electrical wiring 72 and 76 was explained, it is also possible to make a wiring pattern which includes three layers of electrical wiring or more. In this case, it is possible to form the structure from the n-th layer of electrical wiring to the (n+1)-th layer of electrical wiring in the same way as was done during the construction from the first layer of electrical wiring 72 to the second layer of electrical wiring 76.

A Pattern Formation Method

Next, a method for forming the wiring pattern described above will be explained.

FIG. 10 is a process diagram for the method of making the wiring pattern. In the following, the various processes will be explained with reference to FIG. 9B, in the order of the step numbers which are shown in the field at the left edge of FIG. 10. It should be understood that the detailed explanation of structural elements which are the same as in the first preferred embodiment described above is omitted.

First, the surface of the tape shaped substrate 11 is cleansed (in the step 1). In concrete terms, the surface of the tape shaped substrate is irradiated with excimer UV light of wavelength of 172 nm for about 300 seconds. It should be understood that it would also be acceptable to cleanse the surface of the tape shaped substrate 11 with a solvent such as water or the like; and it would also be acceptable to cleanse it using ultrasound. Furthermore, it would also be acceptable to cleanse the tape shaped substrate by irradiating it with a plasma at atmospheric pressure.

Next, as a preliminary to the formation of a backing insulating layer 81 upon the surface of the tape shaped substrate 11, banks (peripheral edge portions) of this backing insulating layer 81 are formed by printing (in the step 2). This printing is performed by applying a liquid drop ejection method (an ink jet method). In other words, a resin material before hardening, which is the material for formation of the backing insulating layer 81, is ejected along the peripheral edge regions of the formation regions of the backing insulating layer 81 using the liquid drop ejection device described previously.

Next, the resin material which has thus been ejected is hardened (in a step 3). In concrete terms, it is irradiated with UV light of wavelength 365 nm for about 4 seconds, and thereby the UV hardening resin, which is the formation material for the backing insulating layer 81, is hardened. By doing this, banks are formed at the peripheral edge portions of the formation region for the backing insulating layer 81.

Next, the backing insulating layer 81 is formed by printing within the banks which have been formed (in the step 4). This printing also is performed by the liquid drop ejection method. In concrete terms, along with scanning the ink jet head of the liquid drop ejection device described above along the entire interior of the banks, the resin material before hardening, which is the material for formation of the backing insulating layer 81, is ejected from this ink jet head. Here, even if the resin material which has been thus ejected flows to some extent, since it is stopped from escaping by the banks which have been formed at the peripheral edge portions which act as barriers, accordingly it does not spread out and get out from the formation region for the backing insulating layer 81.

Next, this resin material which has been thus ejected is hardened (in the step 5). In concrete terms, it is irradiated with UV light of a wavelength of 365 nm fro about 60 seconds, so as to harden the resin material, which is the material for formation of the backing insulating layer 81, and which can be hardened by such UV illumination. By doing this, the backing insulating layer 81 is formed upon the surface of the tape shaped substrate 11.

Next, as a preliminary to the formation of the electrical wires 72 upon the surface of this backing insulating layer 81, the angle of contact of the backing insulating layer 81 is adjusted (in the step 6). As will be described hereinafter, when ejecting the liquid drops which include the material for formation of the electrical wires 72, if its angle of contact with the surface of the backing insulating layer 81 is too great, the liquid drops which are ejected assume a spherical form, and it becomes difficult to form the electrical wires 72 in the prescribed positions and of the prescribed shapes. On the other hand, if the angle of contact with the surface of the backing insulating layer 81 is too small, then the liquid drops which are ejected spread out, and it becomes difficult to enhance the fineness of the electrical wires 72. Since the surface of the backing insulating layer 81 exhibits a lyophobic characteristic, it is possible to adjust the angle of contact of this surface of the backing insulating layer 81 by irradiating it with excimer UV light of a wavelength of 172 nm for about 15 seconds. Although it is possible to adjust the degree of mitigation of the lyophobic characteristic by adjusting the time period for this irradiation with ultraviolet light, it is also possible to adjust it by varying the intensity of the ultraviolet light or its wavelength, or by heat processing, or by a combination of the above processes. It should be understood that, as another method of lyophilization processing, it would also be possible to suggest plasma processing by using oxygen as a reactive gas, or processing by exposure of the substrate to an ozone atmosphere, or the like.

Next, liquid lines 72p, which subsequently will become electrical wires, are formed upon the surface of the backing insulating layer 81 by printing (in the step 7). This printing is done according to a liquid drop ejection method, by using the liquid drop ejection device previously described. In this case, the substance which is ejected is a dispersion liquid in which minute electrically conductive particles, which are the material from which the electrical wiring will be formed, are dispersed in a dispersion medium. Although silver is suitable for use for these minute electrically conductive particles, apart from silver, it would also be possible to utilize the same minute electrically conductive particles as were used in the case of the first preferred embodiment of the present invention, described above. It should be understood that the diameter of the minute electrically conductive particles, and the material with which they are coated and the like, are the same as in the case of the first preferred embodiment. Furthermore, the material for the dispersion medium which is used, its vapor pressure, its surface tension, its viscosity, and so on, are also the same as in the case of the first preferred embodiment described above. Yet further, the concentration and so on of the minute electrically conductive particles, which are the substance which is dispersed, with respect to the dispersion medium, are also the same as in the case of the first preferred embodiment.

The liquid drops of the above described dispersion liquid are ejected from the ink jet head, and are disposed in the locations in which the electrical wires are to be formed. At this time, it is desirable to adjust the amount of overlapping of the liquid drops which are being continually ejected, so that liquid pooling (bulging) does not occur. In particular, it is desirable to perform the ejection, first in a first ejection episode in which the plurality of liquid drops which are ejected are positioned as being mutually separated from one another with gaps between them, and then subsequently in a second ejection episode in which the liquid drops which are ejected are positioned between the abovementioned liquid drops which were ejected in the first ejection episode, so as to fill up said gaps between them.

By doing the above, liquid lines 72p are formed upon the surface of the backing insulating layer 81.

Next, as shown in FIG. 9B, firing of these liquid lines 72p is performed (in the step 8). In concrete terms, this is performed by heating the tape shaped substrate 11 upon which the liquid lines 72p have been formed up to a temperature of 150° C. with a hot plate for about 30 minutes. This firing processing may be performed in a normal atmosphere, but, according to requirements, it may also be performed in an inert gas atmosphere which consists of nitrogen, argon, helium, or the like. It should be understood that although, in the above, the processing temperature for this firing has been specified to be 150° C., it is desirable to set this temperature appropriately, in consideration of the boiling point (the vapor pressure) of the dispersion medium which is included in the liquid lines 72p, the type and pressure of the gas atmosphere in which the process is conducted, the thermal behavior such as the dispersivity and the oxidizability and the like of the minute particles, the presence or absence of a coating material upon them, the temperature resistance characteristics of the base material, and the like. This type of firing processing may be performed by using a normal type of hot plate, or by processing using an electric oven or the like, or by lamp annealing.

By the above described firing processing, the dispersion medium which includes the liquid lines 72p is volatilized, and electrical contact is assured between the minute electrically conductive particles which remain, thus forming the electrical wires 72.

Next (in the step 9) posts 74p in liquid form, which will subsequently become the electrically conducting posts 74, are formed by printing at the end portions of the electrical wires 72 which have been fired. This printing, as well, is performed by a liquid drop ejection method, using said liquid drop ejection device, just like the printing of the liquid lines in the step 7. What is ejected here are liquid drops of the dispersion liquid, in which minute electrically conductive particles, which are the material for formation of the electrically conducting posts 74, are dispersed in a dispersion medium; and, in concrete terms, this liquid is the same as the mass of liquid material which was used for printing the liquid lines 72p. In other words, after having printed the liquid lines 72p, the liquid drops for formation of the electrically conducting posts 74 may be ejected by using the same ink jet head, in which the same mass of liquid material is charged.

Next, as shown in FIG. 9B, the liquid posts 74p which have thus been formed by printing are fired (in the step 10). This firing processing is performed by heating the tape shaped substrate 11 upon which the liquid posts 74p have been formed to a temperature of 150° C. by using a hot plate, for about 30 minutes. By doing this, the dispersion medium which is included in the material of the liquid posts 74p is volatilized, and electrical contact between the minute electrically conductive particles is assured, and thereby the electrically conducting posts 74 are formed.

Next, before forming an intra-layer insulating layer 82 upon the formed layer of the electrical wires 72, the angle of contact of the surface of the backing insulating layer 81 is adjusted (in the step 11). Since the surface of the backing insulating layer 81 which has been hardened exhibits a lyophobic characteristic, in order to make this surface more lyophilic, it is irradiated with excimer UV light of a wavelength of 172 nm for about 60 seconds.

Next, the intra-layer insulating layer 82 is formed by printing so as to surround the electrical wires 72 (in the step 12). This printing is also performed by using a liquid drop ejection device, just like the printing of the backing insulating layer 81. It should be understood that gaps are left open around the electrically conducting posts 74 and the electrical wires 72, and resin material is ejected around the outside thereof.

Next, excimer UV light of a wavelength of 172 m is irradiated for about 10 seconds upon the gaps around the electrically conducting posts 74 and the electrical wires 72, and lyophilization processing is thereby performed (in the step 13). Since, by doing this, a lyophilic characteristic is imparted to the gaps around the electrically conducting posts 74 and the electrical wires 72, accordingly the resin material flows into these gaps, and thereby it contacts with the electrically conducting posts 74 and the electrical wires 72. In this case, the resin material wets over the surfaces of the electrical wires 72, but it does not wet over the upper ends of the electrically conducting posts 74. Accordingly, it is possible to ensure good electrical conduction between the electrically conducting posts 74 and the electrical wiring 76 on the upper layer (which has not yet been formed).

Next (in the step 14), the resin material which has been ejected is hardened. In concrete terms, it is irradiated with UV light of a wavelength of 365 nm for about 4 seconds, and thereby this resin, which can be hardened by UV light, and which is the material for formation of the intra-layer insulating layer 82, is hardened. By doing this, the intra-layer insulating layer 82 is formed.

Next, the inter-layer insulating layer 84 is formed mainly upon the surfaces of the electrical wires 72 by printing (in the step 15). This printing is also performed by using the liquid drop ejection device, just like the printing of the backing insulating layer 81. In this process as well, it is desirable to eject the resin material while leaving gaps around the electrically conducting posts 74.

Next, the resin material which has been ejected is hardened. In concrete terms, it is irradiated with UV light of a wavelength of 365 nm for about 60 seconds, and thereby this resin, which can be hardened by UV light, and which is the material for formation of the inter-layer insulating layer 84, is hardened. By doing this, the inter-layer insulating layer 84 is formed.

Next, the electrical wiring 76 of the upper layer (the next wiring layer) is formed upon the surface of this inter-layer insulating layer 84. The specific method for doing this is the same as described in the steps 6 through 10 above, in which the lower layer of electrical wiring 72 was formed.

Next, an intra-layer insulating layer is formed upon this layer of electrical wiring 76 which has been formed. The specific method for doing this is the same as described in the steps 11 through 14 above, in which the intra-layer insulating layer 82 was formed over the lower layer of electrical wiring 72. Furthermore, if the steps 15 and 16 are performed, it is possible to form an inter-layer insulating layer upon the surface of this upper layer of electrical wiring 76.

Thus it will be understood that, by repeatedly performing the steps from the step 6 through the step 16, it is possible to form as many superimposed layers of electrical wiring as may be desired. It should be understood that a protective layer 88 may be formed over the surface of the uppermost one of these layers of electrical wiring, by the same method as performed in the steps 15 and 16.

With this pattern formation method according to the second preferred embodiment of the present invention, from when the reel to reel substrate is unwound to when it is wound up, only one to a small number from among the above described processes is executed. According to this, it is possible to simplify the pattern formation system, as compared with the first preferred embodiment detailed above, in which almost all the process are executed from when the reel to reel substrate is unwound to when it is wound up. Moreover, with this pattern formation method according to the second preferred embodiment, as the reel to reel substrate is transported from each process to the next process, it is necessary to perform the alignment procedure again. However, if alignment is performed only once for all of the processes, then it becomes possible to perform processing for a plurality of desired regions which are included upon the reel to reel substrate, and this has the merit of being able to cope with large scale production of wiring substrates or the like.

By doing the above, the wiring pattern shown in FIGS. 9A and 9B is formed.

An Electro-Optical Device

The above described pattern formation method is suitable for use for forming a wiring pattern upon a FPC. Thus, a liquid crystal module, which is one example of an electro-optical device for which such a FPC is utilized, will be explained.

FIG. 11 is an exploded perspective view showing a liquid crystal module of a COF (Chip On Film) construction. This liquid crystal module 111, overall, comprises a liquid crystal panel 112 for color display, a FPC 130 which is connected to this liquid crystal panel 112, and an IC 100 for liquid crystal driving, which is mounted to the FPC 130. It should be understood that, according to requirements, an illumination device for backlighting or the like and other supplementary devices may be attached to the liquid crystal panel 112.

This liquid crystal panel 112 comprises a pair of substrates 105a and 105b which are sealed together by a seal member 104, and a quantity of liquid crystal is filled into the so-called cell gap which is defined between these substrates 105a and 105b. To put it in another manner, the liquid crystal is sandwiched between the substrate 105a and the substrate 105b. These substrates 105a and 105b are generally made from a transparent material—for example, glass or a composite resin material or the like. A polarization plate 106a is adhered to the outer surface of the substrate 105a.

Furthermore, electrodes 107a are formed upon the inner surface of the substrate 105a, and electrodes 107b are formed upon the inner surface of the substrate 105b. These electrodes 107a and 107b are made from a transparent material such as, for example, ITO (Indium Tin Oxide) or the like. The substrate 105a has a portion which is extended outwards farther than the substrate 105b, and a plurality of terminals 108 are formed upon this extended portion. These terminals 108 are formed at the same time as the electrodes 107a; i.e., they are formed when forming the electrodes 107a upon the substrate 105a. Accordingly, these terminals 108 are made from, for example, ITO. Among these terminals 108, while a portion of them extend from the electrodes 107a, other ones of them are connected to the electrodes 107b via electrically conducting members not shown in the figures.

On the other hand, wiring patterns 139a and 139b are formed upon the surface of the FPC 130 by a method of wiring pattern formation according to this second preferred embodiment of the present invention. In other words, a wiring pattern 139a form input is formed from one short side of the FPC 130 towards its center, while a wiring pattern 139b for output is formed from the other short side thereof towards its center. Electrode pads (not shown in the drawing) are formed upon end portions towards the center of this wiring pattern 139a for input and this wiring pattern 139b for output.

An IC 100 for liquid crystal drive is mounted to the surface of this FPC 130. In concrete terms, a plurality of bump electrodes which are formed upon the active surface of the IC 100 for liquid crystal drive are connected via an ACF (Anisotropic Conductive Film: an anisotropic electrically conductive layer) with a plurality of electrode pads which are formed upon the surface of the FPC 130. This ACF 160 is made by dispersing a large number of electrically conductive particles within an adhesive resin which is thermoplastic or thermosetting. The so-called COF structure is implemented by mounting the IC for liquid crystal drive upon the surface of the FPC 130 in this manner.

The FPC 130 to which the IC 100 for liquid crystal drive has been mounted is connected to the substrate 105a of the liquid crystal panel 112. In concrete terms, the wiring pattern 139b for output of the FPC 130 is electrically connected via the ACF 140 to the terminals 108 of the substrate 105a. It should be understood that, since the FPC 130 is endowed with flexibility, it becomes possible to implement reduction of the space which it occupies by bending it as desired.

With the liquid crystal module 111 which has the above described structure, signals are inputted to the IC 100 for liquid crystal drive via the wiring pattern 139a for input of the FPC 130. When this is done, drive signals are outputted from the IC 100 for liquid crystal drive to the liquid crystal panel 112 via the wiring pattern 139b for output of the FPC 130. By doing this, it becomes possible to perform image display upon the liquid crystal panel 112.

It should be understood that, as electro-optical devices of the present invention, apart from devices which provide beneficial electro-optical results by altering their transparency ratio for light by changing the refractive index of a substance with an electrical field, there are also included devices which convert electrical energy to optical energy, or the like. In other words, the present invention is not only applicable to a liquid crystal display device, but is also widely applicable to, for example, other types of light generating device, such as an organic EL (Electro-Luminescent) device or a wireless EL device, a plasma display device, an electrophoretic display device, a display device which utilizes an electron emitting element (a Field Emission Display, a Surface Conduction Electron Emitter Display), or the like. For example, a FPC which includes a wiring pattern according to the present invention may also be connected to an organic EL panel, and may also be utilized in the construction of an organic EL module.

### The Third Preferred Embodiment

Next, third preferred embodiments of the pattern formation system and the pattern formation method of the present invention will be explained with reference to the drawings. It is possible to execute the pattern formation method according to this preferred embodiment of the present invention by using the pattern formation system according to this preferred embodiment of the present invention. In these preferred embodiments, by way of giving an example thereof, a pattern formation system and a pattern formation method will be explained for forming wiring made from an electrically conductive layer upon a tape shaped substrate, which is a reel to reel substrate.

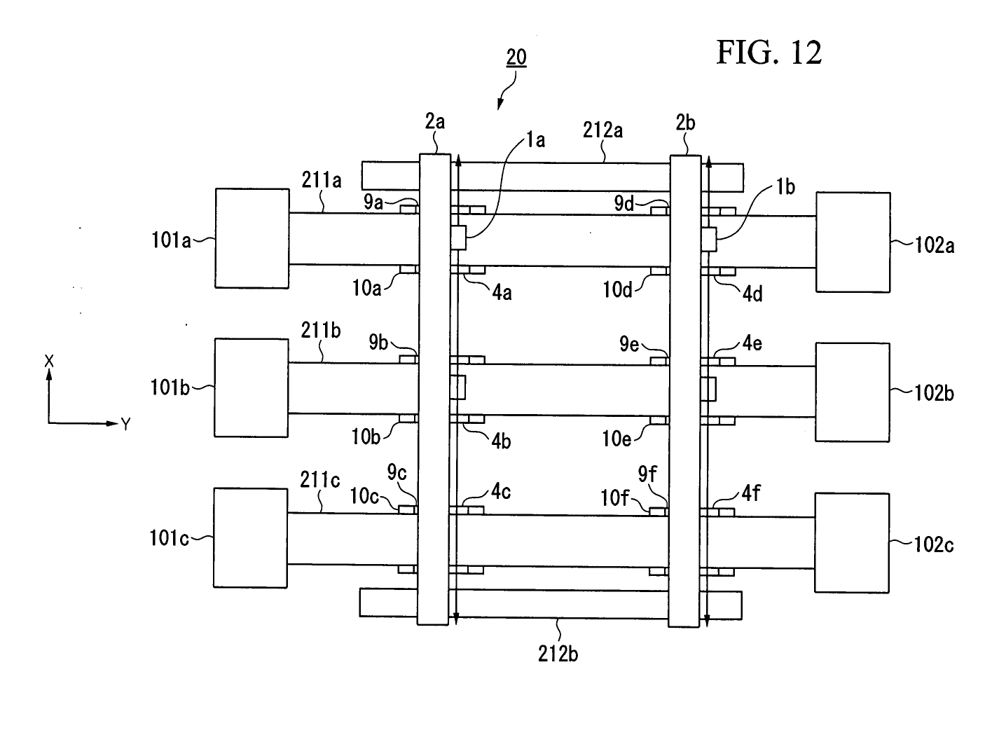

FIG. 12 is a schematic plan view showing the essential portions of a pattern formation system according to the third preferred embodiment of the present invention. This pattern formation system comprises, at least, three first reels 101a, 101b, and 101c, three second reels 102a, 102b, and 102c, and a liquid drop ejection device 20.

A tape shaped substrate 211a is wound up upon the first reel 101a; a tape shaped substrate 211b is wound up upon the first reel 101b; and a tape shaped substrate 211c is wound up upon the first reel 10c. The second reel 102a is a reel upon which the tape shaped substrate which has been pulled off from the first reel 101a is wound up. The second reel 102b is a reel upon which the tape shaped substrate which has been pulled off from the first reel 101b is wound up. The second reel 102c is a reel upon which the tape shaped substrate which has been pulled off from the first reel 101c is wound up. Moreover, the first reels 101a, 101b, and 101c and the second reels 102a, 102b, and 102c constitute substrate positioning means for positioning the plurality of tape shaped substrates 211a, 211b, and 211c mutually parallel to one another.

The liquid drop ejection device 20 comprises two ejection heads 1a and 1b which eject a mass of liquid material in the form of liquid drops towards a plurality of tape shaped substrates 211a, 211b, and 211c which are arranged by the above described substrate arrangement means so as to run mutually parallel to one another.

For these tape shaped substrates 211a, 211b, and 211c, for example, flexible substrates in belt form may be utilized, and these may be made from a base material such as a polyimide or the like. As a concrete example for the form of these tape shaped substrates 211a, 211b, and 211c, they may be 105 mm wide and 200 m long. With each of these tape shaped substrates 211a, 211b, and 211c, the two ends of its belt shape are wound up on, respectively, first reels 101a, 101b, and 101c, and second reels 102a, 102b, and 102c, so that each of these substrates is a “reel to reel” substrate. In other words, the tape shaped substrates 211a, 211b, and 211c are respectively wound off from the first reels 101a, 101b, and 101c, and are respectively wound up on the second reels 102a, 102b, and 102c, so that they are continuously wound forwards in their lengthwise directions (the Y direction). The liquid drop ejection device 20 forms patterns by ejecting a mass of liquid material in the form of liquid drops against these tape shaped substrates 211a, 211b, and 211c which are thus being continuously forwarded.

Furthermore, the liquid drop ejection device 20 comprises guides 2a and 2b which regulate the shift positions of the ejection heads 1a and 1b, and which are arranged so as to cross the plurality of tape shaped substrates 211a, 211b, and 211c. In other words, the guide 2a is an X direction guide shaft for shifting the ejection head 1a in the X direction, while the guide 2b is an X direction guide shaft for shifting the ejection head 1b in the X direction. It should be understood that the ejection heads 1a and 1b, and the guides 2a and 2b, may also be provided as one group, or may be provided as three groups. Furthermore, separate liquid drop ejection devices may be constructed for the ejection head 1a and the guide 2a, and the ejection head 1b and the guide 2b. Yet further, a plurality of ejection heads may be fitted to a single guide (for example, to the guide 2a) so that they can be individually shifted thereupon.

Furthermore, the liquid drop ejection device 20 comprises a plurality of mounting tables (stages) 4a, 4b, 4c, 4d, 4e, and 4f. The mounting table 4a is a stand upon which a desired region of the tape shaped substrate 211a is mounted, and the mounting table 4b is a stand upon which another desired region of the tape shaped substrate 211a is mounted. The mounting table 4b is a stand upon which a desired region of the tape shaped substrate 2111b is mounted, and the mounting table 4e is a stand upon which another desired region of the tape shaped substrate 211b is mounted. The mounting table 4c is a stand upon which a desired region of the tape shaped substrate 211c is mounted, and the mounting table 4f is a stand upon which another desired region of the tape shaped substrate 211c is mounted.

Yet further, the liquid drop ejection device 20 comprises a plurality of cameras 9a, 9b, 9c, 9d, 9e, and 9f. The camera 9a detects the relative position of a mark which is provided upon the desired region of the tape shaped substrate 2111a with respect to the mounting table 4a. The camera 9d detects the relative position of a mark which is provided upon the other desired region of the tape shaped substrate 211a with respect to the mounting table 4d. The camera 9b detects the relative position of a mark which is provided upon the desired region of the tape shaped substrate 211b with respect to the mounting table 4b. The camera 9e detects the relative position of a mark which is provided upon the other desired region of the tape shaped substrate 211b with respect to the mounting table 4e. The camera 9c detects the relative position of a mark which is provided upon the desired region of the tape shaped substrate 211c with respect to the mounting table 4c. The camera 9f detects the relative position of a mark which is provided upon the other desired region of the tape shaped substrate 211c with respect to the mounting table 4f.

Still further, the liquid drop ejection device 20 comprises a plurality of suction attachment mechanisms 10a, 10b, 10c, 10d, 10e, and 10f. The suction attachment mechanism 10a acts based upon the results of detection by the camera 9a, and sucks down the desired region of the tape shaped substrate 211a so as to attach it to the mounting table 4a. The suction attachment mechanism 10d acts based upon the results of detection by the camera 9d, and sucks down the other desired region of the tape shaped substrate 211a so as to attach it to the mounting table 4d. The suction attachment mechanism 10b acts based upon the results of detection by the camera 9b, and sucks down the desired region of the tape shaped substrate 211b so as to attach it to the mounting table 4b. The suction attachment mechanism 10e acts based upon the results of detection by the camera 9e, and sucks down the other desired region of the tape shaped substrate 211b so as to attach it to the mounting table 4e. The suction attachment mechanism 10c acts based upon the results of detection by the camera 9c, and sucks down the desired region of the tape shaped substrate 211c so as to attach it to the mounting table 4c. The suction attachment mechanism 10f acts based upon the results of detection by the camera 9f, and sucks down the other desired region of the tape shaped substrate 211c so as to attach it to the mounting table 4f.

Accordingly, the camera 9a and the suction attachment mechanism 10a constitute an alignment means which determines the position of the desired region of the tape shaped substrate 211a with respect to the mounting table 4a. Moreover, the camera 9d and the suction attachment mechanism 10d constitute an alignment means which determines the position of the other desired region of the tape shaped substrate 211a with respect to the mounting table 4d. Yet further, the camera 9b and the suction attachment mechanism 10b constitute an alignment means which determines the position of the desired region of the tape shaped substrate 211b with respect to the mounting table 4b. Moreover, the camera 9e and the suction attachment mechanism 10e constitute an alignment means which determines the position of the other desired region of the tape shaped substrate 211b with respect to the mounting table 4e. Even further, the camera 9c and the suction attachment mechanism 10c constitute an alignment means which determines the position of the desired region of the tape shaped substrate 211c with respect to the mounting table 4c. Moreover, the camera 9f and the suction attachment mechanism 10f constitute an alignment means which determines the position of the other desired region of the tape shaped substrate 211c with respect to the mounting table 4f.

Furthermore, the liquid drop ejection device 20 comprises two flushing areas 212a and 212b. These flushing areas 212a and 212b are regions which are positioned at the respective opposite sides of the tape shaped substrates 211a, 211b, and 211c, which are arranged so as to be mutually parallel to one another. These flushing areas 212a and 212b are regions in which masses of liquid material are cleansed off from the ejection heads 1a and 1b and are discarded.

Due to this, according to the pattern formation system of this preferred embodiment of the present invention, it is possible to apply the mass of liquid material to the plurality of tape shaped substrates 211a, 211b, and 211c which are arranged so as to run mutually parallel to one another by using the common ejection heads 1a and 1b. By shifting the ejection heads 1a and 1b along the guides 2a and 2b a single time, it is possible to scan these two ejection heads 1a and 1b a single time across the plurality of reel to reel substrates 211a, 211b, and 211c. Accordingly, with the pattern formation system of this preferred embodiment of the present invention, it is possible to apply the mass of liquid material more efficiently, because it is possible to reduce the shifting distance for the ejection heads 1a and 1b, from the overall point of view, as compared to the case of a system which utilizes one individual liquid drop ejection device for each of the reel to reel substrates. Moreover, according to this preferred embodiment of the present invention, it is possible to reduce the number of the liquid drop ejection devices which are required in the construction of the pattern formation system, and accordingly it is possible to reduce the space which is required for this device, and it is also possible to reduce the cost of manufacture thereof.

Yet further, according to the pattern formation system of this third preferred embodiment of the present invention, there are included the plurality of mounting tables 4a, 4b, 4c, 4d, 4e, and 4f upon which the respective desired regions of the plurality of tape shaped substrates 211a, 211b, and 211c are respectively individually mounted, and the alignment means (the cameras 9a, 9b, 9c, 9d, 9e, and 9f and the suction attachment mechanisms 10a, 10b, 10c, 10d, 10e, and 10f) which are provided respectively to each of these mounting tables 4a, 4b, 4c, 4d, 4e, and 4f. By doing this, it is possible to align the respective desired regions of each of the tape shaped substrates 211a, 211b, and 211c, and it is possible to form patterns at high accuracy upon each of these tape shaped substrates 211a, 211b, and 211c.

Even further, according to the pattern formation system of this third preferred embodiment of the present invention, the flushing areas 212a and 212b are disposed at positions which sandwich the plurality of tape shaped substrates 211a, 211b, and 211c from both sides thereof. Due to this, when applying the mass of liquid material with a liquid drop ejection method to the plurality of tape shaped substrates 211a, 211b, and 211c, it is possible to utilize both of these flushing areas 212a and 212b in common, according to requirements. Thus, according to the pattern formation system of this third preferred embodiment of the present invention, it is possible to reduce the shifting distance for the ejection heads 1a and 1b which is required for performing the flushing.

The pattern formation system of this third preferred embodiment of the present invention may also comprise a reel drive section (not shown in the figures) which rotates the second reels 102a, 102b, and 102c all together in the same state. By such a reel drive section, the plurality of tape shaped substrates 211a, 211b, and 211c can all be shifted along their Y directions at the same speed and moreover through the same distance. Accordingly, it is possible to perform the shifting of the plurality of tape shaped substrates 211a, 211b, and 211c from the device which performs each process to the device which performs the next process all together with this single reel drive section. Thus, according to this third preferred embodiment, it is possible further to reduce the cost of manufacture.

### The Fourth Preferred Embodiment

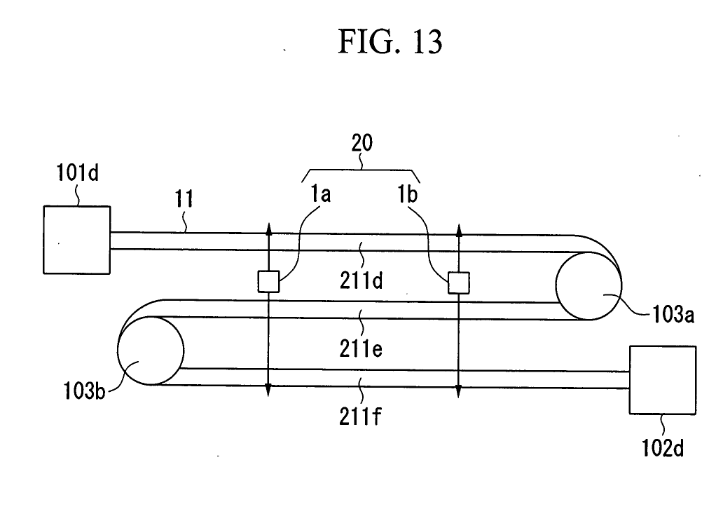

FIG. 13 is a schematic plan view showing the essential portions of a pattern formation system according to the fourth preferred embodiment of the present invention. In FIG. 13, to structural elements which are the same as ones which are shown in FIG. 12, and which have the same functions, the same reference symbols are affixed. This pattern formation system comprises, at least, a single first reel 101d, a single second reel 102d, two rollers 103a and 103b, and a liquid drop ejection device 20.

The tape shaped substrate 11 is wound up on the first reel 101d, and, when it has been pulled off from said first reel 101d, the tape shaped substrate 11 is wound up onto the second reel 102d. It should be understood that, for the tape shaped substrate 11, the same substrate may be utilized as the tape shaped substrates 211a, 211b, and 211c of the above described third preferred embodiment of the present invention. The rollers 103a and 103b are used for keeping the state of the shifting of the tape shaped substrate 11 smooth as it proceeds from the first reel 101d to the second reel 102d, and for turning the tape shaped substrate 11 back upon itself twice. In other words, the tape shaped substrate 11 which has been pulled off from the first reel 101d first passes over the roller 103a and returns upon itself, and then passes over the roller 103b and returns upon itself again, finally being wound up onto the second reel 102d.

As shown in FIG. 13, by arranging the first reel 101d, the rollers 103a and 103b, and the second reel 102d in this manner, three regions 11d, 11e, and 11f of the single tape shaped substrate 11 are defined, and these three regions 11d, 11e, and 11f extend so as to be mutually parallel to one another. The two ejection heads 1a and 1b of the liquid drop ejection device 20 are fitted upon guides 2a and 2b (refer to FIG. 12) which are set up so as to cross the three regions 11d, 11e, and 11f which are arranged to be mutually parallel to one another. Accordingly, it is possible for these two ejection heads 1a and 1b to form patterns upon the three regions 11d, 11e, and 11f by ejecting liquid drops thereupon.

By doing this, according to this fourth preferred embodiment of the present invention, it is possible for the common ejection heads 1a and 1b to form patterns at almost the same time upon the plurality of regions 11d, 11e, and 11f of the single tape shaped substrate 11. Thus, with this pattern formation system according to the fourth preferred embodiment of the present invention, it is possible to form a plurality of patterns at high speed upon the single tape shaped substrate 11, and accordingly it is possible to reduce the cost of manufacture.

### The Fifth Preferred Embodiment

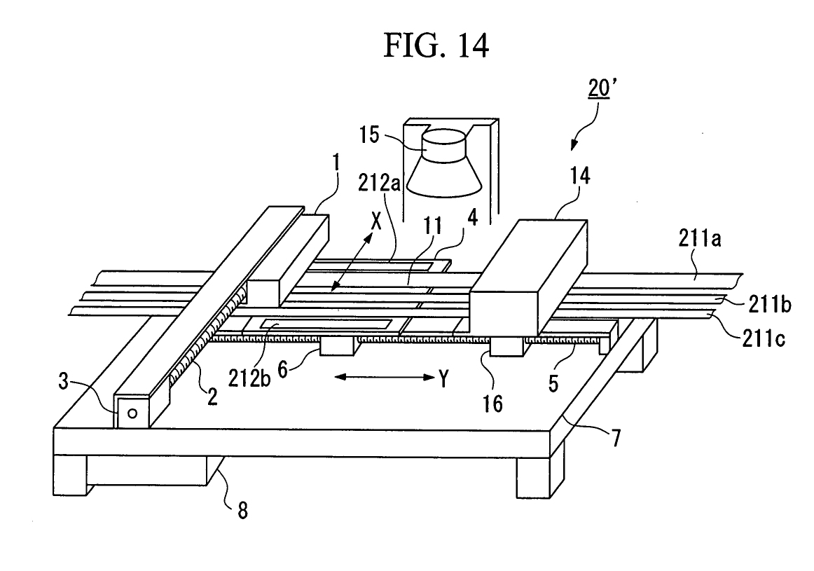

FIG. 14 is a schematic plan view showing the essential portions of a pattern formation system according to the fifth preferred embodiment of the present invention. In FIG. 14, to structural elements which are the same as ones which are shown in FIG. 12, and which have the same functions, the same reference symbols are affixed. In this pattern formation system of this fifth preferred embodiment of the present invention, a portion of its structure of the liquid drop ejection device 20′ is different from the liquid drop ejection device 20 of the third preferred embodiment, but, apart from this, the structure of this pattern formation system according to the fifth preferred embodiment is the same as that of the pattern formation system according to the third preferred embodiment, described above.

This liquid drop ejection device 20′ comprises a single mounting table (stage) 4 upon which desired regions of a plurality of tape shaped substrates 211a, 211b, and 211c are all mounted at the same time, and alignment means (not shown in the figure) which determines the positions of these desired regions of the plurality of tape shaped substrates 211a, 211b, and 211c which are mounted upon the mounting table 4.

With this type of construction, the liquid drop ejection device 20 can utilize the single mounting table 4 for all of the plurality of tape shaped substrates 211a, 211b, and 211c. Thus, with the pattern formation system of this fifth preferred embodiment of the present invention, it is possible to make the structure of the system simpler, and thus it is possible to reduce the cost of forming patterns upon the plurality of tape shaped substrates 211a, 211b, and 211c.

Next, this liquid drop ejection device 20′ will be explained in concrete terms.

This liquid drop ejection device 20′ comprises an ejection head 1, an X direction guide shaft (a guide) 2 for driving the ejection head 1 in the X direction, and an X direction drive motor 3 which rotates the X direction guide shaft 2. The ejection head 1 corresponds to the ejection head 1a of the third preferred embodiment of the present invention shown in FIG. 12. The X direction guide shaft 2 corresponds to the guide 2 of the third preferred embodiment shown in FIG. 12. Furthermore, this liquid drop ejection device 20a comprises the above described mounting table 4 for mounting the tape shaped substrates 211a, 211b, and 211c, a Y direction guide shaft 5 for driving the mounting table 4 in the Y direction, and Y direction drive motors 6 and 16 which rotate said Y direction guide shaft 5. Yet further, this liquid drop ejection device 20′ comprises a main stand 7 upon which the X direction guide shaft 2 and the Y direction guide shaft 5 are fixed in their own individual predetermined positions, and a control device 8 which is located below this main stand 7. Even further, this liquid drop ejection device 20′ comprises a cleaning mechanism section 14 and a heater 15.

In this connection, the X direction guide shaft 2, the X direction drive motor 3, the Y direction guide shaft 5, the Y direction drive motor 6, and the mounting table 4 comprise a head shifting mechanism which shifts the ejection head 1 relatively with respect to the tape shaped substrates 211a, 211b, and 211c which have been aligned to this mounting table 4. Furthermore, the X direction guide shaft 2 is a guide for shifting the ejection head 1 in a direction (the X direction) which intersects the lengthwise direction (the Y direction) of the tape shaped substrates 211a, 211b, and 211c almost perpendicularly, during liquid drop ejection operation from the ejection head 1.

The ejection head 1 comprises a plurality of ink jet heads which apply a dispersion liquid (a mass of liquid material) which includes, for example, minute electrically conductive particles to the plurality of tape shaped substrates 211a, 211b, and 211c at predetermined intervals by ejecting it from nozzles (ejection apertures). Each of this plurality of ink jet heads is arranged to be able to eject the dispersion liquid individually, according to an ejection voltage which is outputted from the control device 8. The ejection head 1 is fixed upon the X direction guide shaft 2, and the X direction drive motor 3 is connected to this X direction guide shaft 2. The X direction drive motor 3 is a stepping motor or the like, and, when a drive pulse signal for the X axis direction is supplied to it from the control device 8, it is arranged to rotate the X direction guide shaft 2. Moreover, when the X direction guide shaft 2 is rotated, it is arranged for the ejection head 1 to be shifted in the X axis direction with respect to the main stand 7. Thus, the plurality of ink jet heads which constitute the ejection head 1 may be taken as having the same structure as the ink jet head 30 shown in FIGS. 3 and 4.

Returning to FIG. 14, the mounting table 4 comprises a mechanism (an alignment mechanism) which fixes each of the tape shaped substrates 211a, 211b, and 211c in its own standard position for application of the dispersion liquid by this liquid drop ejection device 20′. The mounting table 4 is fixed upon the Y direction guide shaft 5, and the Y direction drive motors 6 and 16 are connected to the Y direction guide shaft 5. The Y direction drive motors 6 and 16 are stepping motors or the like, and are arranged to cause the Y direction guide shaft to rotate, when a drive pulse signal for the Y axis direction is supplied from the control device 8. When the Y direction guide shaft 5 is rotated, the mounting table 4 is arranged to be shifted along the Y axis direction with respect to the main stand 7.

The liquid drop ejection device 20′ comprises the cleaning mechanism section 14 which cleans the ejection head 1. This cleaning mechanism section 14 is arranged to shift along the Y direction guide shaft 5 by operation of the Y direction drive motor 16. This shifting of the cleaning mechanism section 14 is also controlled by the control device 8.

Next, flushing areas 212a and 212b of the liquid drop ejection device 20′ will be explained.

As shown in FIG. 14, the two flushing areas 212a and 212b are provided upon the mounting table 4 of the liquid drop ejection device 20′. These flushing areas 212a and 212b correspond to the two flushing areas 212a and 212b of FIG. 12. These flushing areas 212a and 212b are regions which are disposed at both the ends in the short direction (the X direction) of the group of tape shaped substrates 211a, 211b, and 211c, and they are regions to which the ejection head 1 can be shifted by the X direction guide shaft 2. In other words, the flushing areas 212a and 212b are located at both the sides of the desired regions, which are regions of the tape shaped substrates 211a, 211b, and 211c which correspond to a single circuit substrate. These flushing areas 212a and 212b are regions in which dispersion liquid (a mass of liquid material) can be cleaned off from the ejection head 1 and discarded. By positioning the flushing areas 212a and 212b in this manner, it is possible to shift the ejection head 1 quickly along the X direction guide shaft 2 to whichever of these flushing areas 212a and 212b is the most convenient (i.e. is the closer). For example, if the ejection head 1 comes to be in a state in which flushing is desired while it is in the vicinity of the flushing area 212b, then the ejection head 1 is not shifted to the flushing area 212a which is comparatively far away, and which accordingly would take a comparatively large amount of time to reach, but is shifted to the flushing area 212b which is comparatively close, so that flushing can be performed quickly.

A heater 15 is a means for performing heat processing of the tape shaped substrates 211a, 211b, and 211c by lamp annealing. In other words, along with evaporating the solvent in the masses of liquid material which have been ejected upon these tape shaped substrates 211a, 211b, and 211c by the liquid drop ejection heads, the heater 15 is also able to perform heat processing for converting the dried result into electrically conductive layers upon these tape shaped substrates 211a, 211b, and 211c. The turning on and off of the supply of electrical power to this heater 15 is also arranged to be controlled by the control device 8.

With the liquid drop ejection device 20′ according to this fifth preferred embodiment of the present invention, in order to eject the dispersion liquid upon predetermined wiring formation regions of the tape shaped substrates 211a, 211b, and 211c, for example, predetermined drive pulse signals are supplied from the control device 8 to the X direction drive motor 3 and/or the Y direction drive motor 6, and the ejection head 1 and the tape shaped substrates 211a, 211b, and 211c are shifted relatively to one another by the resulting shifting of the ejection head 1 and/or the mounting table 4. During this relative shifting, predetermined ejection voltages are supplied from the control device 8 to the ink jet heads 30 of the ejection head 1, so that the dispersion liquid is ejected from said ink jet heads 30.

With the liquid drop ejection device 20′ according to this fifth preferred embodiment of the present invention, it is possible to adjust the ejection amounts of the liquid drops from the ink jet heads 30 of the ejection head 1 by changing the magnitude of the ejection voltages which are supplied from the control device 8. Furthermore, the pitch of the liquid drops which are ejected upon the tape shaped substrates 211a, 211b, and 211c is determined according to the relative shifting speed of the ejection head 1 with respect to the tape shaped substrates 211a, 211b, and 211c, and according to the ejection frequency of liquid drops from the ejection head 1 (i.e. according to the frequency of the ejection voltage supply).

The Pattern Formation Method

Next, an example of a pattern formation method according to this fifth preferred embodiment of the present invention will be described with reference to FIG. 1 and so on. In FIG. 1, the tape shaped substrate 11 corresponds to the tape shaped substrates 211a, 211b, and 211c of FIGS. 12 and 14, or to the tape shaped substrate 11 of FIG. 13. As an example of this fifth preferred embodiment of the present invention, a case will be described of a pattern formation method, in which the above described pattern formation system according to the fifth preferred embodiment of the present invention is used for forming wiring patterns which consist of electrically conductive layers upon a plurality of tape shaped substrates 11 which are arranged so as to run mutually parallel to one another.

In this pattern formation method there are included a plurality of processes, each of which is executed upon a plurality of reel to reel substrates which consist of a plurality of tape shaped substrates 11 by a plurality of devices (including the liquid drop ejection device 20). In the following, among this plurality of processes which are executed upon each of the tape shaped substrates 11, the processes which are performed upon a single one of the tape shaped substrates 11 will be explained, by way of example.

As this plurality of processes, for example, there may be cited a cleansing process S1, a surface processing process S2, a first liquid drop ejection process S3, a first hardening process S4, a second liquid drop ejection process S5, a second hardening process S6, and a firing process S7. By these processes, it is possible to form a wiring layer and an insulating layer and the like upon the tape shaped substrate 11.

Furthermore, in this pattern formation method, the tape shaped substrate 11 is divided into portions of predetermined length along its lengthwise direction, thus defining a large number of substrate formation regions (desired regions). The tape shaped substrate 11 is continuously shifted to each device for carrying out each process, and thereby a wiring layer and an insulating layer and the like are continuously formed upon each of the substrate formation regions upon the tape shaped substrate 11. In other words, the plurality of processes S1 through S7 are executed by the plurality of devices as though upon an assembly line, either at the same time or overlapped in time. Moreover, it is also desirable for the timing for shifting from each of the plurality of processes to the next process to be arranged to be almost the same for each of the tape shaped substrates 11.

Next, each of the above described plurality of processes which are executed upon each of the tape shaped substrates 11 will be explained in concrete terms.

First, the cleansing process S1 is executed upon the desired region of the tape shaped substrate 11 which has been pulled off from the first reel 100 (in the step S1).

As a concrete example of this cleansing process S1, there may be cited irradiation of the tape shaped substrate 11 with UV light (ultraviolet light). Furthermore, it would also be acceptable to cleanse the tape shaped substrate 11 with a solvent such as water or the like, or to cleanse it by using ultrasound. Yet further, it would also be acceptable to cleanse the tape shaped substrate 11 by irradiating it with a plasma at atmospheric pressure.

Next, the surface processing process S2 is performed upon the desired region of the tape shaped substrate 11 upon which the above cleansing process S1 has been performed, in order to endow it with a lyophilic or a lyophobic characteristic (in the step S2).

A concrete example of this surface processing process S2 will now be explained. In order to form a wiring pattern consisting of an electrically conductive layer in the subsequent first liquid drop ejection process S3 of the step S3 by using a liquid which includes minute electrically conductive particles upon the tape shaped substrate 11, it is desirable to control the wettability of the surface of the desired region of the tape shaped substrate 11 with respect to this liquid which includes minute electrically conductive particles.

It is possible to use the surface processing method which was explained for the step S2 in the pattern formation system and the pattern formation method of the first preferred embodiment of the present invention, described above, as a surface processing method for obtaining the desired angle of contact, in this fifth preferred embodiment of the present invention as well.

Moreover, in this fifth preferred embodiment, it is desirable for the FAS which was explained above with reference to the first preferred embodiment of the present invention to be used as a compound for forming a self organized layer, from the points of view of good adherence to the substrate and capability for imparting the desired lyophobic characteristic.

Such a FAS is generally structurally designated by RnSiX(4−n). Here, n is an integer from 1 to 3, and X is a hydrolyzed base such as a methoxy base, an ethoxy-base, or a halogen atom or the like. R is a fluoro-alkyl-base having the structure (CF3)(CF2)x(CH2)y (here, x is an integer between 0 and 10, and y is an integer between 0 and 4); and, if a plurality of R or of X are combined with Si, it will be acceptable for the R or the X all to be the same, or they may also be different. The hydrolyzed base designated by X forms silanol by hydrolysis, and combines with the substrate by siloxane combination by reacting with the hydroxyl base of the backing substrate (such as glass, silicon, or the like). On the other hand, since R comprises a fluoro-base such as (CF3) or the like on its surface, it does not wet the backing surface such as the substrate or the like (its surface energy is low), and reforms upon the surface.

Next, the first liquid drop ejection process S3 is performed (in the step S3), which constitutes a wiring material application process in which a liquid which includes minute electrically conductive particles is ejected upon the desired region of the tape shaped substrate 11 upon which the above described surface processing process S2 has been carried out.

The liquid drop ejection in this first liquid drop ejection process S3 is carried out with the liquid drop ejection device 20, 20′ of the above described preferred embodiments. When forming the wiring upon the tape shaped substrate 11, the mass of liquid material which is ejected by this first liquid drop ejection process is a mass of liquid material which includes minute electrically conductive particles (which constitute a pattern formation component). As such a mass of liquid material which includes minute electrically conductive particles, there is used a dispersion liquid in which the minute electrically conductive particles are dispersed within a dispersion medium. The minute electrically conductive particles which are used here may be minute metallic particles which include any one of gold, silver, copper, palladium, nickel, or the like, or they may be minute particles of an electrically conductive polymer or of a superconducting material.

Furthermore, as the ejection material and the ejection method which are employed in this first liquid drop ejection process, the ejection material and the ejection method which were employed in the step S3 of the pattern formation system and the pattern formation method according to the first preferred embodiment of the present invention, described above, may be employed.

Next, the first hardening process is carried out (in the step S4) upon the desired region upon the tape shaped substrate 11, upon which the above described first liquid drop ejection process S3 has been carried out.

This first hardening process S4 constitutes of a wiring material hardening process, in which the mass of liquid material which includes the minute particles of electrically conductive material which has been applied upon the tape shaped substrate 11 in the first liquid drop ejection process S3 described above is hardened. By repeatedly executing the above described steps S3 and S4 (including, if appropriate, the step S2), it is possible to increase the thickness of the resulting layer, and it is possible to form a wiring pattern of the desired shape and moreover of the desired thickness in a simple and easy manner.

As a concrete example of this first hardening process S4, the concrete example which was used in the step S4 of the pattern formation system and the pattern formation method of the first preferred embodiment of the present invention, described above, may be employed.

Next, the second liquid drop ejection process S5, which is an insulating material application process, is carried out (in the step S5) upon the desired region of the tape shaped substrate 11 upon which the first hardening process S4, described above, has been carried out.

The liquid drop ejection device shown in FIGS. 12 and 13 may also be used for the liquid drop ejection in this second liquid drop ejection process S5. However, it is desirable for the liquid drop ejection device 20 which is used in the first liquid drop ejection process S3 and the liquid drop ejection device 20 which is used in the second liquid drop ejection process S5 to be different devices. By using different liquid drop ejection devices for these two processes S3 and S5, it is possible to carry out both the first liquid drop ejection process S3 and also the second liquid drop ejection process S5 at the same time, and accordingly it is possible to count upon increase of the speed of manufacture and enhancement of the ratio of utilization of the liquid drop ejection devices.

This second liquid drop ejection process S5 is a process in which a mass of liquid material which has an electrically insulating characteristic is applied with a liquid drop ejection device to the upper layer of the wiring layer which has been formed upon the tape shaped substrate 11 with the above described first liquid drop ejection process S3 and first drying process S4. In other words, this mass of liquid material which has an electrically insulating characteristic is applied to the entire predetermined region upon the tape shaped substrate 11 by using the liquid drop ejection device 20. By this procedure, the wiring pattern which has been formed by using the first liquid drop ejection process S3 and the first hardening process S4 is covered with an insulating layer. Before carrying out this second liquid drop ejection process S5, it is desirable to perform surface processing analogous to the surface processing process S2 which was performed in the above described step S2. In other words, it is desirable to carry out lyophilization processing upon the entire predetermined region of the tape shaped substrate 11.

Next, the second hardening process S6 is carried out (in the step S6) upon the desired region of the tape shaped substrate 11, upon which the second liquid drop ejection process S5 has been performed.

This second hardening process S6 constitutes of an insulating material hardening process, in which the mass of liquid material which has an insulating characteristic and which has been applied upon the tape shaped substrate 11 in the second liquid drop ejection process S5 described above is hardened. As a concrete example of this second hardening process S6, for example, there is a method of hardening the mass of liquid material which has been applied to the tape shaped substrate 11 by drying it; and, in more concrete terms, the method of hardening it by UV irradiation may be cited. By repeatedly executing the above described steps S5 and S6 (including, if appropriate, a surface processing process), it is possible to increase the thickness of the resulting insulating layer, and it is possible to form an insulating layer of the desired shape and moreover of the desired thickness in a simple and easy manner. As a concrete example of this second hardening process S6, the same concrete example as was cited for the first drying process S4 described above may be employed.

The above described steps S2 through S6 constitute a first wiring layer formation process A by which a first wiring layer is formed. After this first wiring layer formation process A, by further performing the above described steps S2 through S6 again, it is possible to form a second wiring layer as an upper layer over the first wiring layer. The process of forming this second wiring layer constitutes a second wiring layer formation process B. After this second wiring layer formation process B, by further performing the above described steps S2 through S6 yet again, it is possible to form yet a third wiring layer as an upper layer over the second wiring layer. The process of forming this third wiring layer constitutes a third wiring layer formation process C. By repeating the above described steps S2 through S6 in this manner as many times as appropriate, it is possible to form as many layers of wiring as desired upon the tape shaped substrate 11 in a simple and yet effective manner.

Next, after having formed the first wiring layer, the second wiring layer, the third wiring layer, etc . . . using the above described steps S2 through S6, the firing process S7 is performed (in the step S7) upon the desired region upon the tape shaped substrate 11.

This firing process S7 is a process in which the wiring layer(s) which have been subjected to drying processing after having been applied by the first liquid drop ejection process S3 and the insulating layer(s) which have been subjected to drying processing after having been applied by the second liquid drop ejection process S5 are fired all together. By this firing process S7, the electrical contact between the minute particles of the wiring pattern(s) of the wiring layer(s) upon the tape shaped substrate 11 is ensured, and these wiring pattern(s) are converted into electrically conductive layer(s). Furthermore, the insulation characteristic of the insulating layer(s) which have been laid down upon the tape shaped substrate 11 by the second liquid drop ejection process S5 is enhanced.

Here, for this firing processing, the firing processing method which was explained in the step S7 of the pattern formation system and the pattern formation method of the first preferred embodiment of the present invention, described above, may be applied.

Since, in this manner, according to the pattern formation method of this fifth preferred embodiment of the present invention, it is possible to form wiring patterns at the same time upon the plurality of tape shaped substrates 11, i.e. upon the plurality of reel to reel substrates, accordingly it is possible to manufacture an electronic substrate which carries a wiring pattern in an efficient manner and moreover in high quantities at high speed, without sacrificing manufacturing quality. In other words, after having formed the desired pattern, using the liquid drop ejection device 20, upon the desired regions of the plurality of tape shaped substrates 11, by shifting these tape shaped substrates 11 with respect to this liquid drop ejection device 20, it is possible to form another wiring pattern upon other desired regions of the tape shaped substrates 11 in an extremely simple manner.

Yet further, according to the pattern formation method of this fifth preferred embodiment of the present invention, it is possible to execute a plurality of processes, including the above described liquid drop application process, from when the tape shaped substrates 11 are wound off from the first reels 101 until they are wound up upon the second reels 102. By doing this, it is possible to shift these tape shaped substrates 11 simply by winding the one ends of the tape shaped substrates 11 up onto the second reels 102, from the device which executes the cleansing process S1 to the next device which executes the surface processing process S2, and next to the next device which executes the next process, and so on in order. Accordingly, with this fifth preferred embodiment of the present invention, it is possible to simplify the transport mechanism and the alignment mechanism which shift each of the tape shaped substrates 11 to each device for performing each of the processes, and it is thus possible to reduce the space which is required for setting up this manufacturing device, and to reduce the cost of manufacture for large scale production.

Moreover, according to the pattern formation method of this fifth preferred embodiment of the present invention, it is desirable to ensure that the time period which is required for each of the processes among the plurality of processes is almost the same. If this is done, it is possible to execute the various processes at the same time in parallel, and accordingly, along with it being possible to perform the manufacturing process more quickly, it is also possible to enhance the efficiency of utilization of each device for performing each of the processes. Thus, it is desirable to adjust the number and/or the performance of the various devices (for example, of the liquid drop ejection device 20) which are used for implementing the various processes, in order to make the time periods which are required for each of the processes agree with one another. For example, if the second liquid drop ejection process S5 takes a longer time than does the first liquid drop ejection process S3, then it may be desirable to provide a single liquid drop ejection device 20 for performing the first liquid drop ejection process S3, and to provide two liquid drop ejection devices 20 for performing the second liquid drop ejection process S5.

Furthermore, with the pattern formation method of this preferred embodiment, it is preferable for the timing for shifting from each of the plurality of processes to the next process to be the same for all of the plurality of tape shaped substrates 11. When this is the case, it is possible to carry out the various processes at the same time in parallel upon all of the plurality of tape shaped substrates 11. Accordingly, with this preferred embodiment, along with it being possible to perform the manufacturing operation at high speed, it is also possible to enhance the efficiency of utilization of each device in each process.

An Electronic Device

Next, an electronic device which has been manufactured using the pattern formation system and/or the pattern formation method of the above described preferred embodiment will be explained.

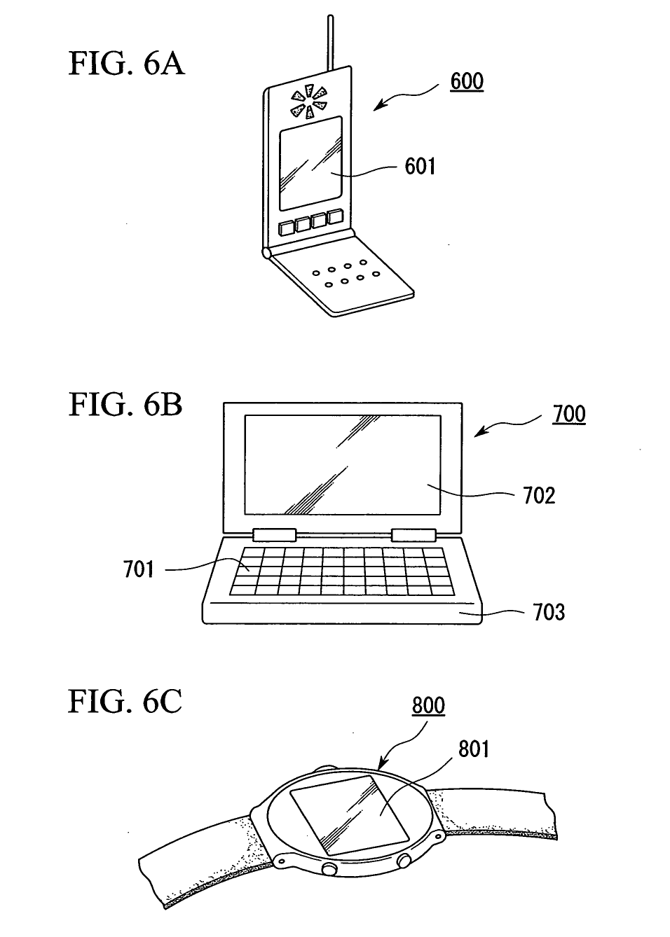

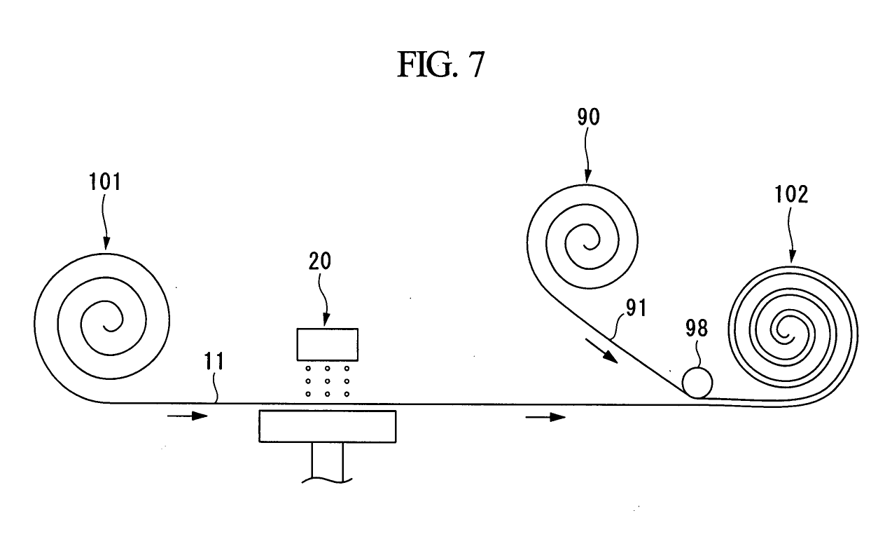

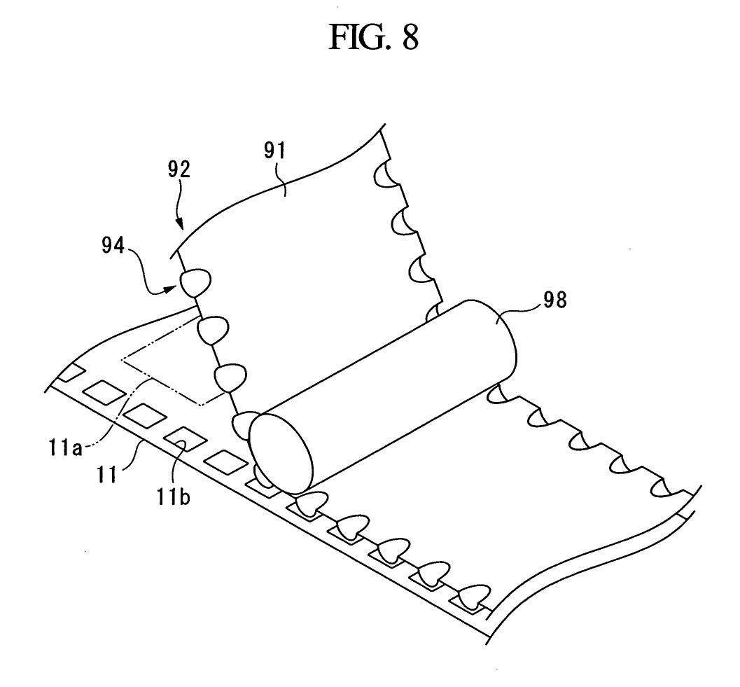

FIG. 6A is a perspective view showing an example of a portable telephone. In FIG. 6A, the reference symbol 600 denotes the main body of the portable telephone, in which a wiring pattern has been formed by employing a pattern formation system and/or a pattern formation method according to an embodiment of the present invention as detailed above; and the reference symbol 601 denotes a display section, which consists of an electro-optical device. FIG. 6B is a perspective view showing an example of a portable type information processing device such as a word processor, a personal computer, or the like. In FIG. 6B, the reference symbol 700 denotes the information processing device, the reference symbol 701 denotes an input section such as a keyboard or the like, the reference symbol 702 denotes a display section such as an electro-optical device or the like, and the reference symbol 703 denotes the main body of the information processing device, within which there is provided a wiring pattern which is made by using a pattern formation system and/or a pattern formation method according to an embodiment of the present invention as detailed above. FIG. 6C is a perspective view showing an example of a wristwatch type electronic device. In FIG. 6C, the reference symbol 800 denotes the wristwatch main body, within which there is provided a wiring pattern which is made by using a pattern formation system and/or a pattern formation method according to an embodiment of the present invention as detailed above; and the reference symbol 801 denotes a display section, which is an electro-optical device.

Since the electronic devices shown in FIG. 6A-6C include wiring patterns which have been made by using a pattern formation system and/or a pattern formation method according to an embodiment of the present invention as detailed above, they can be made at low cost and in high volume, while maintaining a good product quality.

It should be understood that the technical range of the present invention is not limited to the above described preferred embodiments; it is possible to make various changes or additions to the present invention, provided that its gist is not departed from, and it should be understood that the concrete details of the materials or of the layer structure of any embodiment of the present invention are not to be considered as being limited to the ones shown and described above, but may be varied as appropriate. For example, although in the above described preferred embodiments the pattern formation system and the pattern formation method of the present invention have been described in terms of the manufacture of a wiring pattern, the present invention is not to be considered as being limited to that particular application; it may be applied to the manufacture of various types of integrated circuit, or to the production of various types of electro-optical device, such as an organic EL device, a plasma display device, a liquid crystal device or the like; and the present invention may also be applied to the manufacture of a color filter. In other words, the object which is manufactured by using the pattern formation system or the pattern formation method of the preset invention is not limited to being a wiring pattern; it is also possible to manufacture picture elements, electrodes, or various type of semiconductor element or the like by employing the pattern formation system or the pattern formation method of the preset invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A pattern formation method for forming a pattern upon a reel to reel substrate, which is a tape shaped substrate whose both end portions is wound up, respectively, by using at least, a liquid drop ejection method in which a liquid material is applied by being ejected in the form of liquid drops.

2. The pattern formation method as claimed in claim 1, wherein a plurality of processes, including a liquid drop application process by said liquid drop ejection method, are executed from when said reel to reel substrate is unwound to wound up.

3. The pattern formation method as claimed in claim 2, wherein at least two processes of said plurality of processes are performed at the same time.

4. The pattern formation method as claimed in claim 2, wherein:
said plurality of processes includes, at least, a hardening process; and
said hardening process is executed after applying said liquid material upon said reel to reel substrate by said liquid drop ejection method.

5. The pattern formation method as claimed in claim 2, wherein the time which is required for each of said plurality of processes is almost the same.

6. The pattern formation method as claimed in claims 2, wherein said plurality of processes includes:
a cleansing process in which the surface of said reel to reel substrate is cleansed;
a surface processing process in which a lyophilic characteristic or a lyophobic characteristic is imparted to the surface of said reel to reel substrate;
a wiring material application process in which the liquid material which includes an electrically conductive material is applied to said reel to reel substrate by said liquid drop ejection method;
a wiring material drying process in which said liquid material which includes said electrically conductive material is dried;
an insulating material application process in which the liquid material which has an insulating characteristic is applied by said liquid drop ejection method to the upper layer of the region upon which said wiring material drying process has been performed; and
an insulating material hardening process in which said liquid material which has said insulating characteristic is hardened.

7. The pattern formation method as claimed in claim 6, wherein said plurality of processes includes a firing process in which said reel to reel substrate is fired after performing at least said insulating material application process.

8. The pattern formation method as claimed in claim 1, wherein a wiring material application process in which a pattern is printed upon said reel to reel substrate by ejecting said liquid drops including an electrically conductive material is performed from when said reel to reel substrate is unwound to when it is wound up; and
said reel to reel substrate is wound up before hardening said liquid material printed on said reel to reel substrate.

9. The pattern formation method as claimed in claim 8, wherein the winding up of said reel to reel substrate is performed in a state in which said printed liquid material is tentatively dried to an extent at which said printed liquid material has lost its flowability.

10. The pattern formation method as claimed in claim 8, wherein the winding up of said reel to reel substrate is performed while positioning a tape shaped spacer which covers the application region of said liquid material on the surface of said tape shaped substrate upon which said liquid material is applied.

11. The pattern formation method as claimed in claim 10, wherein:
convex portions are formed upon the surface of said tape shaped spacer; and
the winding up of said reel to reel substrate is performed while contacting said convex portions of said tape shaped spacer on a region of said tape shaped substrate other than said application region of said liquid material.

12. The pattern formation method as claimed in claim 11, wherein:
said convex portions are formed on both end portions of said tape shaped spacer in its widthwise direction;
winding up holes of said tape shaped substrate are formed in a row along both end portions in the widthwise direction of said tape shaped substrate; and
the winding up of said reel to reel substrate is performed while engaging the ends of said convex portions of said tape shaped spacer into said winding holes in said tape shaped substrate.

13. A pattern formation system comprising:
a first reel upon which a tape shaped substrate is wound;
a second reel upon which said tape shaped substrate pulled off from said first reel is wound up;
a liquid drop ejection device which comprises an ejection head which ejects a liquid material as liquid drops to said tape shaped substrate which is pulled off from said first reel; and
a head shifting mechanism which drives said ejection head relatively to said tape shaped substrate pulled off from said first reel.

14. The pattern formation system as claimed in claim 13, wherein said liquid drop ejection device further comprises a guide rail which causes said ejection head to move in a direction substantially perpendicular to the lengthwise direction of said tape shaped substrate during the liquid drop ejection operation by said liquid drop ejection device.

15. The pattern formation system as claimed in claim 14, further comprising flushing areas which are regions arranged at both sides of said tape shaped substrate in its width direction, said ejection head moving to said flushing areas via said guide to eject and discard said liquid material to be cleaned off said ejection head.

16. The pattern formation system as claimed in claim 13, wherein said tape shaped substrate is wound up upon said second reel with the surface upon which said liquid material is applied facing inwards.

17. The pattern formation system as claimed in claim 13, wherein said liquid drop ejection device comprises an ejection head which ejects liquid drops towards the front surface and the rear surface of said tape shaped substrate at almost the same time.

18. The pattern formation system as claimed in claim 13, wherein said liquid drop ejection device comprises an ejection head which ejects liquid drops towards the front surface and the rear surface of said tape shaped substrate at almost the same time while holding said surfaces of said tape shaped substrate in a substantially vertical orientation.

19. The pattern formation system as claimed in claim 13, further comprising a reversing mechanism which twists said tape shaped substrate so as to interchange its front surface and its rear surface, and wherein:
said liquid drop ejection device comprises a first ejection head which ejects liquid drops toward the upper surface of said tape shaped substrate before twisted by said reversing mechanism, and a second ejection head which ejects liquid drops toward a new upper surface of said tape shaped substrate after twisted by said reversing mechanism.

20. A pattern formation system comprising:
a substrate arrangement means which arranges a plurality of tape shaped substrates so that they are mutually parallel; and
a liquid drop ejection device comprising at least one ejection head which ejects a liquid material in the form of liquid drops toward said plurality of tape shaped substrates which is arranged by said substrate arrangement means.

21. The pattern formation system as claimed in claim 20, wherein said tape shaped substrates are reel to reel substrates whose end portions are wound up, and
said liquid drop ejection device regulates the shift position of said ejection head, and comprises a guide which is arranged so as to cross said plurality of tape shaped substrates.

22. The pattern formation system as claimed in claim 20, wherein said liquid drop ejection device comprises a plurality of said ejection heads.

23. The pattern formation system as claimed in claim 22, wherein said plurality of ejection heads are all supported in common by said guide so as to be able to shift.

24. The pattern formation system as claimed in claim 21, wherein said liquid drop ejection device comprises a plurality of said guides, and each of said plurality of said guides supports at least one of said ejection heads so that it is able to shift.

25. The pattern formation system as claimed in claim 20, further comprising a reel drive section which shifts said plurality of tape shaped substrates along their lengthwise directions in common.

26. The pattern formation system as claimed in claim 25, wherein said reel drive section comprises a plurality of reels, one of which is provided for each of said plurality of tape shaped substrates, and said plurality of reels, upon each of which one of said tape shaped substrates is wound up, are rotated all together.

27. The pattern formation system as claimed in claim 20, wherein said liquid drop ejection device comprises a plurality of stages, upon each of which a desired region of one of said plurality of tape shaped substrates is mounted, and a plurality of alignment means, each of which determines the position of a corresponding one of said desired regions of said tape shaped substrates mounted upon a corresponding one of said stages.

28. The pattern formation system as claimed in claim 20, wherein said liquid drop ejection device comprises a stage upon which the desired regions of said plurality of tape shaped substrates are simultaneously mounted, and an alignment means which determines the positions of said desired regions of said tape shaped substrates mounted upon said stage.

29. The pattern formation system as claimed in claim 20, further comprising a pair of flushing areas which are a pair of regions in which liquid material is cleansed off and discarded from said ejection head and positioned outward of said tape shaped substrates in the width direction of said plurality of tape shaped substrates which are disposed by said substrate arrangement means so as to be mutually parallel to one another.

30. A pattern formation method for forming a pattern comprising:
an arrangement process in which a plurality of reel to reel substrates are arranged so as to be mutually parallel to one another, each of said reel to reel substrates is a tape shaped substrates whose end portions are wound up; and
a liquid drop application process in which a liquid material is applied to said plurality of reel to reel substrates by being ejected in the form of liquid drops using a common ejection head.

31. The pattern formation method as claimed in claim 30, further comprising a plurality of processes including said liquid drop application processes from when said reel to reel substrates are unwound to when they are wound up and wherein
said plurality of processes are executed upon said plurality of reel to reel substrates while being mutually overlapped in time.

32. The pattern formation method as claimed in claim 31, wherein the timing for shifting from each process to the subsequent process in said plurality of processes is almost the same for all of said plurality of reel to reel substrates.

33. A pattern formation method in which a pattern is formed, comprising the steps of:
folding a single tape shaped substrate to and from in its lengthwise direction, so that a plurality of locations upon said tape shaped substrate in its lengthwise direction extend parallel to one another; and
performing a liquid drop application process in which a liquid material is applied to said plurality of locations by being ejected in the form of liquid drops using a common ejection head.

34. An electronic device manufactured using a pattern formation method as claimed in claim 1.

35. An electronic device manufactured using a pattern formation system as claimed in claim 13.
